(19) United States
(12) Patent Application Publication
(10) Pub. No.: US 2003/0074244 A1
(43) Pub. Date: Apr. 17, 2003

(54) Distributed energy technology assurance

(76) Inventor: Charles R. Braxton, Meredith, NH (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/123,063

(22) Filed: Apr. 11, 2002

Related U.S. Application Data
(60) Provisional application No. 60/283,231, filed on Apr. 11, 2001.

(51) Int. Cl. G06F 17/60

(52) U.S. Cl. 705/7; 705/412; 702/183

(57) ABSTRACT

A system and method for providing value assurance products and services in the context of distributed power projects is presented. Some aspects relate to describing and estimating the remaining life of a project or components of a multi-component distributed power project. The system and method also allow for calculation of residual values of one or more components of the multi-component project, and thereby allow for more economical underwriting policies and more realistic financial risk descriptions, which further allow for mitigating said financial risks. A variety of data are taken as inputs to a processing engine that uses the data inputs as parameters of an economic model and presents outputs from the model to clients over a network. Exemplary inputs include operational data, historical data and jurisdictional data describing rules and regulatory constraints in the jurisdiction in which the project resides.

### RELATED APPLICATIONS

This application claims priority under 35 U.S.C. §119(e) to U.S. provisional patent application Serial No. 60/283,231, filed Apr. 11, 2001, entitled “Method for the Pricing of Energy Technology Assurance Services” the disclosure of which is incorporated herein by reference in its entirety.

### TECHNICAL FIELD

The present invention relates generally to the providing of energy services and technologies, and in particular, to the providing assurance services for distributed power technologies using a computer system and a data network.

### BACKGROUND

Distributed power (DP) technology involves the strategic location and use of modular units that generate or store electrical energy near consumers and load centers so as to provide benefits to customers and/or support for operation of a power grid. Units may be stationary or mobile.

Generators operate on a variety of fuels and technologies. Conventional technologies include diesel or natural gas-fired reciprocating engines and aero-derivative combustion turbines. There are also numerous emerging DP technologies. For example, fuel cells such as proton-exchange membrane (PEM) cells, can be used to provide several kilowatts (kW) of electric power. These cells utilize a pair of electrodes separated by an electrolyte, wherein hydrogen is ionized, providing the charged particles for electric current generation. Other fuel cells, such as the solid-oxide fuel cell (SOFC) rely on ionizing oxygen in a hot air tube for the supply of electrons.

Microturbines are another energy technology used in DP systems. The turbines do not require a supply of hydrogen, but instead they typically rely on natural gas as a fuel. Microturbines range in capacity from 25 kW to 500 kW. Furthermore, microturbines, normally include only one main moving part (the rotor), which can ride on gas bearings so that maintenance costs and failure rates are low.

Other DP energy generation technologies include solar cells, or photovoltaics, which use semiconductor panels to absorb solar energy, causing some electrons to be dislodged from the semiconductor surface. These charges are then used to provide electric current to the load. The cost of solar power devices is dropping rapidly, making them a promising technology for DP systems, especially in geographic regions where an abundance of sunshine and an inadequate conventional power grid might exist. Electric energy storage includes batteries and flywheels.

A general discussion of the economics of DP can be found in a white paper by Arthur D. Little, Inc., Distributed Generation: Understanding the Economics, 1999, and in Distributed Generation: System Interfaces, 1999, also a white paper by Arthur D. Little, Inc.

Other terms for DP are distributed energy or distributed energy resources. Parts of the DP spectrum have been referred to as distributed power generation, district energy, distributed generation (DG), cogeneration, combined cycle, combined heat and power (CHP), and uninterruptible power supplies (UPS), among others. Applications for DP have been referred to as prime power, baseload power, battery backup, backup power, standby power, power conditioning, power protection, peaking power, peak-shaving power, stand alone or grid isolated, reserve power, etc., among others. All of these terms and others are encompassed in the term distributed power (DP) as used herein.

DP is now an emergent economic option as a result of four primary trends in the electric industry: electric industry restructuring, growing demand for electricity, technology advancements, and rising concern for environmental issues. These four trends will be briefly discussed below.

1. Electric industry restructuring: Utilities that were vertically integrated are restructuring in horizontal markets for generation, transmission and distribution. New entities are emerging, including power GENerating COmpanies (GENCOs), power TRANSmission COmpanies (TRANSCOs), and power DIStribution Companies (DISCOs). These new entities must respond to market forces as well as regulatory mandates. And they have to manage information and risks in ways that satisfy customer needs.

Unregulated GENCOs compete in wholesale markets based on the efficiency, availability and flexibility of their plants. Federally-regulated TRANSCOs operate in an environment where uncertainties about pricing and returns make operators hesitant to invest in new facilities. DISCOs continue to be regulated at the state level under new regulatory compacts such as price caps or incentive rate mechanisms. Unlike traditional rate-based regulation, the new regulatory mechanisms provide little incentive for DISCOs to invest in facilities until the needs are certain to provide adequate return and favorable rate impacts.

Prior to restructuring, capacity planning and dispatch were done on a utility franchise level with regulatory oversight state-by-state. Control areas, or “power pools”, provided mutual aid reliability and support, but operated primarily on technical and economic rules rather than dynamic market forces. With deregulation, merchant plants (exempt wholesale generators) will rely more heavily on real time market and pricing information. Independent System Operator organizations are being reconstituted to fulfill this need for merchant plants. However, today DP systems lack the infrastructure and standardization to participate cost-effectively in this new market environment.

2. Growth in demand: In the U.S., at least, demand for electricity is expected to grow at an annual rate of 2.5-3% over the next 15 years. The installed capacity of electric power generation in the U.S. is 750 million kilowatts (kW), or 750 Gigawatts (GW). The U.S. Department of Energy's Energy Information Administration Energy Outlook, 1999 report projects a need for 363 GW of new capacity generation between now and the year 2020 to meet both the growing demand and to offset the retirement of aging coal and nuclear plants. Economic effects of deregulation and environmental compliance to date have already reduced reserve generating capacity. Since the approval process for building new merchant scale generating plants continues to be lengthy and uncertain, DP can fulfill localized capacity demands more quickly in many cases.

The U.S. Department of Energy (DOE) estimates that the current installed base of one DP application, combined heat and power (CHP), is currently 53 GW. The DOE estimates that a technical potential of 75 GW exists in the commercial market (office buildings, institutions, etc.) and 90 GW in the industrial market. The total technical potential of 165 GW means that over 40% of the forecasted new capacity requirements could be met by CHP applications alone.

Other applications and market segments have significant potential. In the telecommunications network segment, applications of DP may exceed 40 GW with units sized from 1 kW to 200 kW. The single family residential segment for DP may be another 40 GW with units sized from 5 kW to 40 kW.

3. Advances in DP technology: DP technology differs fundamentally from the traditional central generation-transmission-distribution model. DP can better fit market needs because it has advantages in efficiency, scale, location, flexibility, and environmental/siting benefits.

Particular DP generating technologies include combustion turbines, steam turbines, microturbines, internal combustion/diesel engines operating on a variety of fuels, fuel cells, and photovoltaics. DP storage technologies include batteries with several types of chemistry and so-called “dynamic-” or “rotary-power protection” which uses flywheel technology.

Generally, DP is smaller, more modular, and installed closer to its end use consumption point than the traditional central electric generating station or merchant power plant. The size range of DP is from 10 kW to 300 MW for power generation units and 1 kW and up for storage units. Thus, DP units packaged in modular configurations require less time and cost for site work, and have less need for new transmission and distribution infrastructure.

DP also differs from the central plant model in communication, command and control. The traditional model optimized its dispatch within its franchise area, and to a lesser extent in the regional power pool, through centralized control. By contrast, DP control is distributed among a variety of parties and may optimize a variety of criteria for consumers, energy suppliers, or a portion of a distribution/transmission network. DP can achieve superior communication and control, because of the smaller scale modular nature of DP units. Two-way communications over cable or wireless telecommunications channels and/or the internet is common.

While central generating plants operate with a large on-site workforce, DP provides real time access for diagnostics, monitoring and calibration by remotely located service organizations.

4. Environmental benefits: DP compares favorably with central generation in several environmental aspects. First, large-scale “irretrievable” resource commitments (land, air, water, viewscape) are less likely with most DP applications. Traditional generating stations have lengthy and uncertain approval processes to address these concerns. Second, DP technology also differs fundamentally from the traditional central generation-transmission-distribution technologies in its overall efficiency. The fuel efficiency of a DP generator can equal or exceed a central unit's efficiency. In addition, on a full cycle basis, DP units have better load following capabilities than traditional central generation facilities. Finally, by locating DP close to the point of use, efficiencies are realized through reduced line losses, combined heat and power operations, and other tailoring that is not practical in a large-scale generator.

Most DP installations contain at least three elements: DP equipment (energy technology units); DP upkeep (or repair, maintenance, or overhaul) agreement, and a DP site contract (agreement for the owner to use some space and infrastructure at a location). Though the trends mentioned previously have begun to stimulate demand for DP, the value of each of these elements of DP cannot be quantified or easily transferred today. Consequently, end use customers pay for value that cannot be monetized. The ability to quantify the value of each DP installation will be beneficial for the industry, and will result in a DP pricing shift to reflect the benefits with robust secondary markets for these value elements.

DP sales and delivery channels are currently fragmented and traditional. The traditional business models for DP distribution channels are (1) equipment sales and service and, (2) Engineer-Procure-Construct (EPC) firms that take short-term turnkey responsibility for planning, design and installation.

As electric industry deregulation evolves, new business models for DP distribution are appearing with new DP offerings. These channels include developers, performance contractors and Energy Service Providers (ESPs). Developers design, build, operate/maintain and, where desired, own DP facilities for customers relieving them of the obligations of ownership. Performance contractors or energy services companies (ESCOs) offer various performance guarantees and shared savings arrangements with asset ownership by the customer or the supplier.

ESCO offerings could also take the form of “chauffage” contracts; that is, contracts in which the consumer pays for all costs on the basis of the units of converted energy delivered (e.g., heat, light, climate, or electricity). ESPs, also known as marketers, primarily sell and trade energy commodity and capacity. ESPs may use DP to complement transactions, to provide additional trading options, or to optimize services and meet performance commitments to their customers. Another new channel is the DP aggregator who assembles new and existing DP systems into a marketable block under direct control for dispatch. These new channels offer the prospect of moving end use customer' decisions on DP from a capital purchase to a performance purchase.

So long as DP sales channels retain the paradigm of the direct equipment sale in their offers, customers will continue to view DP as a capital equipment purchase and DP will continue to represent a small fraction of the nation's power supply. Customers expect capital purchases to be deferrable decisions requiring extensive time and direct involvement in assessment of alternatives, equipment selection, system design, planning and implementation. These customer expectations contribute to lengthy sales cycles and wasteful, excessive transaction costs for DP. In turn, high costs and slow sales are further reflected in DP energy output costs.

There are nearly 1,000 firms acting as sales channels for DP in the U.S. With the various business models present in DP distribution channels, it would appear that consumers have extensive choice in DP pricing, contract terms and services. In fact, offerings from all channels are simply variations of direct equipment sales because almost all of the risks are passed through to the end user and none of the additional value elements are unlocked.

Consequently, end users must accept long contract terms or make “life cycle costed” investment decisions spreading the risks (and costs) over the longest period of time in order to receive DP energy prices low enough to justify the investment. As the term of the contract gets longer, the end user faces risks such as changing business conditions, constraints on business flexibility, and inability to respond to new developments in energy markets.

The sales channels lack the risk management tools, financial services and information infrastructure to shift DP from ala carte offerings to mass customized unlocking of value. Many sales channels continue to confuse time-consuming activity with truly profitable ways to add value for customers. In other words, despite the promising marketplace and multiplicity of traditional and new distribution channels for DP, something is missing in the marketplace so that DP struggles to meet its potential. This struggle is less an indication of channel competence than a reflection of missing business methodology and infrastructure that is needed to create a stronger role for DP in the electric supply market.

A need exists for methods to facilitate doing business in the DP industry, especially in view of some complexities in rules and regulations at the federal and local levels. Variations in regulations, rules, enforcement, codes, and standards for such matters as engineering, fire, electrical, buildings, and siting are a dynamic problem requiring tracking of, and can be in themselves intractable for the DP provider because of the multiple jurisdictions encountered. While the sales channels have knowledge of some set of jurisdictions in the geographies in which they operate, it is difficult to extend their capabilities to new jurisdictions in a cost-effective manner.

There also exists a problem in financing and operating DP projects, which are not only influenced by their initial values (purchase price) but also in their residual values. The risk of insuring the projects has been too high because of ambiguities and the traditional methodology used by insurers to guarantee a no-loss outcome. The insured has paid excessive rates, which further detracts from the economic value of the project.

The DP industry needs an infrastructure that can obtain and distribute this data so that small scale, modular DP units can be cost effectively deployed by a variety of channels over a patchwork of jurisdictions. Additionally, the expense of negotiating and executing agreements in the energy market is too high to allow for small-scale projects to effectively benefit from careful agreement structuring, especially given the number of energy jurisdictions which complicate the drafting of proper documents

While energy technologies and technical developments have made large strides, there has not been a corresponding improvement in the economics of DP energy technology. The business of energy technology procurement, investment, operation, and maintenance remains modeled on the old system of customer-loaded risk. The customer continues to suffer a lack of options in the DP energy technology market. This in turn reduces the competitive ability of DP in the overall energy market.

### SUMMARY

If DP is going to realize its full potential and compete in the energy market, sales channels need to give consumers simpler offerings with shorter terms and lower prices. This will not occur if left to manufacturers and their sales channels. These entities have neither the business paradigm nor the broad market scope needed to drive standardization and create a universal infrastructure that can recognize the full value of DP.

Additional choices and lower prices will only come about when a business infrastructure exists so that the channels can shift risk away from end users and monetize and quantify other sources of value in DP that sales channels currently ignore. Once the infrastructure exists, sales channels can create new offerings and thus share any economic advantage with DP consumers or end users.

The energy technology assurance methods explained below address many of the problems discussed above, particularly for the DP industry, and would permit the DP industry to approach more fully its potential.

One embodiment is directed to a method for producing a pricing option corresponding to an economic risk in a multi-component distributed power project, comprising collecting operational data corresponding to at least one component of the distributed power project; obtaining historical data corresponding to said at least one component from a historical data source; performing a processing function according to a model, which uses the operational data and the historical data, to yield an output corresponding to a future residual value of the at least one component; and presenting a user with a pricing option for the distributed power assurance service, based at least in part on the future residual value of the at least one component.

Another embodiment is directed to a system for pricing assurance services for a multi-component distributed power project, said project having at least one distributed power component, the system comprising a source of operational data corresponding to the component; a source of historical data corresponding to the component; a computer processing engine that receives the operational data and the historical data and uses a model to produce a pricing option corresponding to an assurance service for the project; and a server, receiving the pricing option from the computer processing engine, coupled to a network and running an application service portal (ASP) application by which a user can receive the pricing option from the server.

Yet another embodiment is directed to a method for quantifying an economic risk to an underwriter insuring a multi-component distributed power project, comprising collecting operational data corresponding to a component of the multi-component distributed power project; obtaining historical data corresponding to the component of the multi-component distributed power project; estimating a remaining useful life of the component at least as a function of the operational data and the historical data; estimating a future residual value of the project at least as a function of the remaining useful life of the component; and determining the economic risk for the underwriter at least as a function of the future residual value of the project.

One embodiment is directed to an application service portal (ASP), comprising a processing engine receiving live operational data and historical data corresponding to a component of a multi-component distributed power project, the processing engine adapted for carrying out calculations to yield a pricing option using the live operational and the historical data; a World Wide Web server accessible to a client over a network, the server receiving results of the actuarial calculations from the processing engine; wherein the ASP presents said pricing option to said client.

Another embodiment is directed to a method for estimating an economic risk associated with a contract for sale or service of a multi-component distributed power project, comprising breaking the multi-component project into at least one discrete components; collecting live operational data corresponding to the at least one discrete component; collecting historical data corresponding to the discrete component; estimating the useful remaining life of the discrete component; estimating the residual value of the discrete component at a future date; estimating the residual value of the project based at least on the estimated residual value of the discrete component; and estimating the economic risk associated with the contract based at least on the estimated residual value of the project.

One embodiment is directed to a method for underwriting a distributed power project, comprising dividing the project into discrete components which can be analyzed individually; estimating a remaining useful life of at least one discrete component of the project based at least on operational data and historical data corresponding to the discrete component; estimating an accrual rate for upkeep services associated with maintaining the at least one discrete component; using the remaining useful life and the upkeep accrual rate to calculate a residual value for the at least one discrete component; and underwriting the distributed power project based at least on the residual value.

Another embodiment is directed to a system for providing project value assurance services in a distributed power project, comprising a jurisdictional knowledge unit that collects and parses information relating to a jurisdiction within which the distributed power project resides; an economic processing engine, receiving information from the jurisdictional knowledge unit, said economic processing engine performing calculations; and a user interface, receiving an output from the economic processing engine, said user interface providing a user with a standardized document in response to user input containing information about the project and the jurisdiction in which the project lies.

Yet another embodiment is directed to an application service portal (ASP), comprising a processing engine receiving live operational data and historical data corresponding to a component of a multi-component distributed power project, the processing engine adapted for carrying out calculations to yield a pricing option using the live operational and the historical data; a World Wide Web server accessible to a client over a network, the server receiving results of the actuarial calculations from the processing engine; wherein the ASP presents said pricing option to said client.

According to one aspect, a method is disclosed for pricing energy technologies and services, comprising collecting information from at least one input data source, performing an actuarial processing function on the data using a processor, and presenting a user with at least one pricing option for the energy technology or services.

In other embodiments, a system is disclosed for pricing energy technologies and services, comprising an energy technology unit, sources of data, and a computing engine. The energy technology unit, sources of data, and computing engine are adapted for coupling to a communication network capable of carrying data useful for producing pricing options for the energy technology or services.

In almost all embodiments, the system described and the method for carrying out the invention may make use of a variety of data or voice networks and associated techniques and apparatus. For example, a network, as the term is used herein may be the Internet or the World Wide Web as well as dedicated or generic cable, fiber, satellite, cellular, paging, or wireless communication channels now in operation, or those to be implemented in the future.

In another aspect, standardized documents are produced using the steps of collecting information from at least one data source adapted for coupling to a network, performing an actuarial processing function on the data, using a processor adapted for coupling to the network, wherein the data source and the processor use the network for communication relevant to arriving at the terms of the standardized documents.

In some embodiments, the method of presenting the contract terms and pricing options to clients may be carried out over any of the communication channels described above, for example, an application service portal (ASP), comprising a secure World Wide Web server and related software. The server can be accessible to a client computer over the Internet, wherein the ASP is implemented in a computer adapted for receiving data from a processing engine, the processing engine is adapted to perform actuarial and dynamic rating of energy technology economic decisions and pricing packages, and the ASP presents the economic decisions and pricing packages to the clients.

In another embodiment, a method is provided for dynamic rating of the economic advantages of energy technologies and services, comprising the steps of performing an actuarial processing function on data related to a DP component or service, and presenting a user with at least one pricing option for said energy technology or service. Optionally, an electronic market exchange is provided which is accessible to clients as well as interested participants and where value elements covered and created by standardized documents can be bought or sold for varying time periods. This exchange may operate in the present system or transmit data to another energy market exchange through an alliance.

Many forms of input data may be used for the actuarial and the dynamic rating computations. These include data that resides in a database archive, for example on a dedicated database server, or on the same server functioning as the economic processing engine, or the ASP server. The data can also be culled from online and offline media by search or lookup methods known to those skilled in the art.

Other forms of data are obtained from such sources as the energy technology units, or processors or memory installed therein, data from human or machine log entries, manufacturer reports and maintenance records, client records, and jurisdictional regional and federal databases can also be used to further improve the quality of service and value. These data and their sources cannot be exhaustively listed, but a table of some exemplary types of input data and their uses is given in the Appendix in Table 1.

Another aspect includes a processing engine implemented in a computer, comprising a network connection connecting the processing engine to at least one source of data relating to energy technology units and services, an actuarial processor operating on data relating to energy technologies, a dynamic rating engine operating on data relating to energy technologies and data obtained from said actuarial processor, and a data connection to an application service provider, adapted for providing economic decisions and pricing packages to a client over a network connecting said client to said application service portal.

Another embodiment is directed to a method for producing a pricing option corresponding to an economic risk in a multi-component distributed power project, comprising collecting operational data corresponding to at least one component of the distributed power project; obtaining historical data corresponding to said at least one component from a historical data source; performing a processing function according to a model, which uses the operational data and the historical data, to yield an output corresponding to a future residual value of the distributed power project; and presenting a user with a pricing option for the distributed power assurance service, based at least in part on the future residual value of the at least one component.

### BRIEF DESCRIPTION OF THE DRAWINGS

Aspects of the present invention will be more clearly appreciated from the following detailed description when taken in conjunction with the accompanying drawings, in which like reference numerals indicate like structures or method steps associated therewith.

FIG. 1 is a schematic diagram illustrating an exemplary process for providing energy technology or service options;

FIG. 2 is a schematic diagram illustrating one embodiment of an energy technology assurance service;

FIG. 3 is a schematic diagram illustrating examples of data flow, processes, and outputs;

FIG. 4 is a schematic diagram illustrating an embodiment of input and output parameters; and

FIG. 5 is a schematic diagram illustrating further exemplary aspects of input and output data flow in an energy technology assurance service framework;

FIG. 6 is a schematic diagram illustrating information flow and structure of an exemplary residual value assurance framework;

FIG. 7 shows an exemplary embodiment of a data processing system; and

FIG. 8 shows an exemplary embodiment of a data storage system.

FIG. 9 shows an exemplary embodiment of a process for estimating economic risk and mitigating said economic risk.

### DETAILED DESCRIPTION

As discussed above, many present needs in the DP industry are left unsatisfied, particularly with respect to the financial options available to DP project operators and those who finance and insure such projects. As a result, the DP industry is not approaching its potential. One unmet problem is that DP project valves are treated as having relatively high risk and financiers protect themselves with high charges. One area in which financiers perceive high risk is residual value and project life forecasting. Therefore, it would be useful to provide services to the DP industry that allow for better residual value determination and assurance, as well as assurance for the value of the project upon transfer to a new owner, such as upon resale. The insurers and financiers of a DP project can offer better and more competitive rates and terms to the project operator if they have access to reliable assurance that the economic risk of involvement in the project is limited to a known amount. The residual value of the project may be enhanced, and the risk involved in forecasting residual value may be reduced, in several ways, as discussed below.

By breaking a DP project into sub-components in a multi-component project, it is possible to perform all of the analysis described herein on any single asset or component, then transfer that knowledge to a larger framework for assuring the residual value of the entire project as a whole. The value-limiting components can be identified and the dependencies thereon can be assessed and incorporated into the economic model used for valuing the entire system. The operational data can be monitored by instruments and collected in real-time over communication networks like the Internet, or may be collected in quasi-real-time such as by batch downloading the data to the system for analysis. Historical or archived data (e.g., maintenance logo) may be similarly collected over communication networks at various intervals, or may be supplied by a data collection service.

Furthermore, by incorporating live operational data from instruments attached to the equipment of a project, and by measuring the operational conditions and duty cycling, and by taking into account historical logged or archived maintenance and reliability information, better decisions can be made regarding the remaining useful life of a component or a project.

Additionally, jurisdictional data, which may be dynamic, can be incorporated through a jurisdictional knowledge unit and/or database to better define the economic environment in which the project is operated.

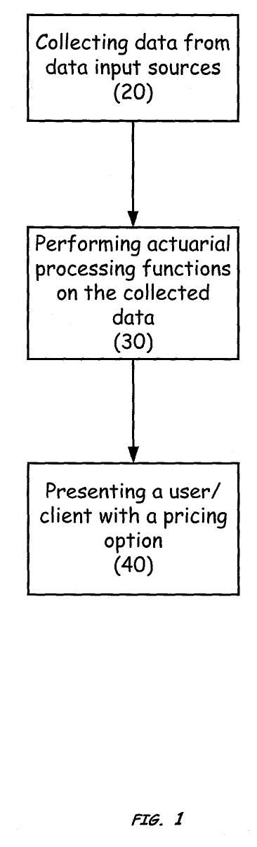

With reference to the drawings, and more particularly to FIG. 1, a general description of the method of the invention will be provided. In this illustrative example, the method includes three acts. First, input data from data input sources is collected in act 20. Second, an actuarial processing function is performed on the collected data in act 30. Finally, a pricing option for an energy technology or service is presented to a client in act 40. These acts will be described in greater detail in conjunction with the systems for implementing this method and illustrative examples.

It should be understood that the “client”, also sometimes called a “user”, may be in the form of machines (i.e., a computer or computers) as well as a person. For example, a computer belonging to a subscribing entity, or an energy technology unit itself, with or without an onboard processor, can also access needed information. The information may be used in raw form or further processed to yield other valuable or useful derivative data. This further processing of data obtained may provide a further source of revenue.

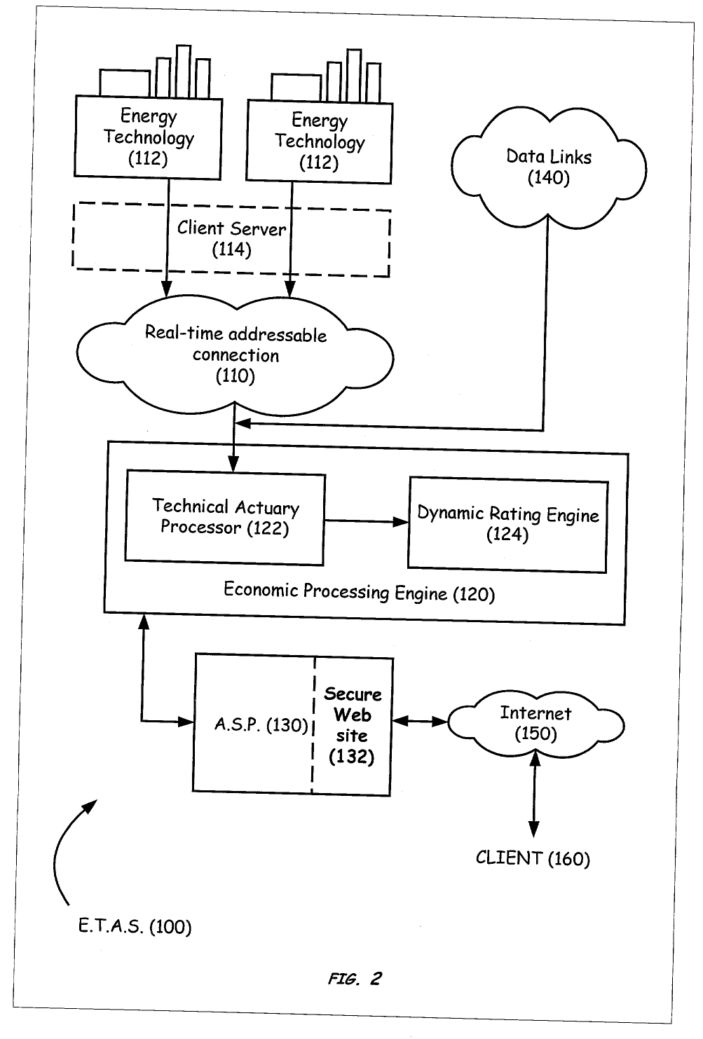

FIG. 2 is a schematic diagram illustrating one embodiment of a system for carrying out the method of FIG. 1, referred to as the energy technology assurance services (ETAS) (100) system, comprising four major interrelated elements: a real-time addressable connection 110, an economic processing engine 120, an application service portal (ASP) 130, and a network data link 140.

Other auxiliary elements and related data may be required, depending on the application. The function and interrelationship of the major components of the ETAS 100 in this illustrative embodiment are discussed below.

A Real-Time Addressable Connection 110 (or near-real-time addressable connection) is used between the installed energy technologies (ET) 112 at the client' customer' project sites that provides a flow of data (Project Data) on operating variables, conditions and status via a secure network (e.g., the Internet or telecommunications) to the ETAS. The addressable connection 110 can be direct between the project and ETAS 100, or can come from a client server 114 to ETAS. Any one of several interface standards and proprietary or open communications protocols that are defined and supplied by others may be used for the connection 110.

Economic Processing Engine 120 is normally a computer-implemented engine running on a server, and comprises two main logical components: a Technical Actuary Process 122 and a Dynamic Rating Engine 124.

A Technical Actuary Process 122, carries out known or proprietary statistical algorithms, statistical analysis tools, expert networks, manufacturer or independent test data-driven calculations, computer-based historical tracking and forecasting models, and technical and economic best practices that utilize data from technical actuary analyses, audits and studies, and provides input to the dynamic rating engine 124.

The Dynamic Rating Engine 124 accepts outputs from the technical actuary processor 122 and the data links 140 and provides continually-updated results and pricing data to the ASP 130 for client use or used by participants in a market exchange.

The Application Service Portal (ASP) 130, is normally implemented on a server accessible to clients 160 over the Internet 150 via a secure web site 132 that hosts continually-updated software which draws upon the dynamic rating engine 124 and can be used by clients 160 in several ways, for example: to develop and evaluate new offerings for their customers; to structure specific deals and present internally consistent presentations for the customer and client upper management approval; to obtain revenue accounting data for each project and summary data to provide input to the client's general ledger (customer billing and collection services may be provided to clients through an automated clearinghouse if desired; for clients to obtain summary valuation of present and planned portfolios of energy technology projects; and to access technical and economic information on best practices concerning installation, contracts, mobilization and equipment selection maintained by the technical actuary processor and/or via web links to vendors. Archived summary proforma project data from all clients provides input to the technical actuary processor 122 and dynamic rating engine 124 for use in forward pricing of assurance services.

Data Links 140 use a communication network such as the World Wide Web (WWW), Local Area Networks (LAN), or Wide Area Networks (WAN), either from alliances or accessory services to the dynamic rating engine 124 and the technical actuary processor 122 are used. These provide data needed for calculation of terms and pricing packages consistent with the client's 160 selections in the ASP 130, such as automated clearing house (billing and collection services), property and casualty insurance and other business interruption insurance, financial services, global secondary markets for used equipment, and jurisdictional or regional secondary markets for portfolios of sited DP systems, upkeep agreements, retail energy services, or wholesale ancillary commodity services.

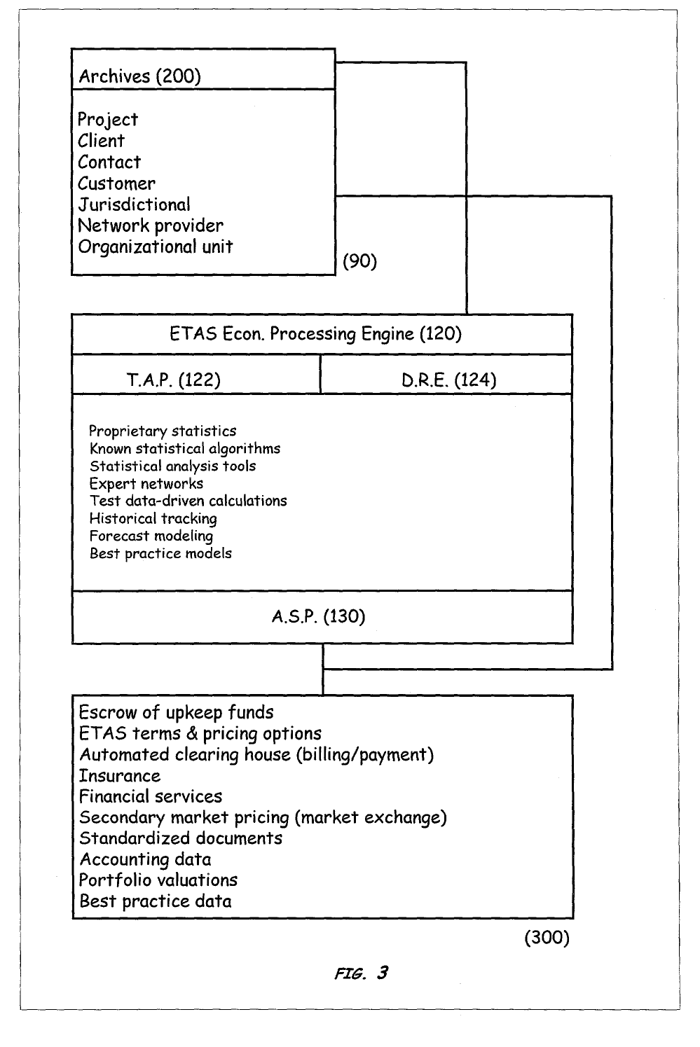

FIG. 3 shows the information flow for an ETAS implementation in accordance with an exemplary embodiment of the present invention. Numerous specific data types and a non-exhaustive list of examples of some of these data are given in Table 1 for illustrative purposes.

The input data 90, come from one or more sources, for example, data links 140 or from real-time addressable connections 110 as shown in FIG. 2, as well as archived databanks 200, project data, customer data, unit data, contact data, jurisdictional data, network data, upkeep provider data, organizational data, and others.

The collected and archived data is then processed in the ETAS economic processing engine 120. The technical actuary processor (T.A.P.) 122 performs any number of operations of the data using a set of actuarial techniques, such as by using proprietary statistical algorithms, statistical algorithms that are known in the field, statistical analysis tools, expert networks, test data-driven calculations, historical tracking, forecast modeling, and best practice models.

The dynamic rating engine (D.R.E.) 124 also performs a set of steps on the input data and the results it obtains from the technical actuary processor 122, a client or project data source, ASP inputs, and underwriters of assurance services, and makes decisions based on these inputs. The rating engine 124 also provides valuation as well as risk mitigation services to underwriters.

Examples of the inputs obtained from client or project data sources which are used by the dynamic rating engine 124 are: the address of the project (physical address, tax map, etc.); the type of installed equipment; the type of end user (commercial, industrial, healthcare, government, etc.); the type of application (island, grid supported, grid connected, etc.); the type of operation (peaking, standby, baseload, etc.); and other inputs such as planned accruals for upkeep costs.

The dynamic rating engine 124 also takes inputs from the technical actuary processor 122, which optionally transforms incoming data from operating projects as well as field data collected and entered independently. Examples of this data are: maintenance experience (costs, time, etc.) possibly listed by jurisdiction, equipment type, or other features; maintenance forecasts by jurisdiction, equipment type, etc.; mean time to failure forecasts; and failure mode analyses.

Other sources of data, such as underwriters of assurance services may provide inputs such as pricing parameters useful for calculation of user pricing options.

The input data and any intermediate actuarial processing results may be used by the dynamic rating engine 124 to produce output results useful to the ETAS client 160. The dynamic rating engine 124 uses these inputs to continually evaluate and update scores on the equipment, maintenance practices, costs, etc. This ability to perform real-time scoring enables the ETAS system to access continually-updated pricing data, including that from underwriters, and to validate the adequacy of upkeep accrual rates and other parameters.

The outputs of the dynamic rating system 124 are pricing data. The pricing outputs are either levelized fixed rates or dynamically-priced rates. These rates apply to assurance services and to the upkeep accrual. If the operation and maintenance accrual that the client entered is adequate for the type of pricing intended, then the ETAS validates the client's decision. The pricing outputs of the dynamic rating system 124 go into financial analysis and customer pricing models that clients access through the ASP over the Internet for example. In the case where a client chooses dynamically-priced assurance services and upkeep rates, the dynamic rating system 124 will stream the periodic updates to the client's pricing for the project and these rates will be reflected either in the customer billing or in the client billing, depending on the way in which the client has chosen to present the pricing information to the customer. These outputs also provide the basis for market exchange pricing that is combined with participant bids and offers.

The results (300) from the ETAS are presented to a client 160 by the ASP 130. The nature of the results 300 will vary according to the client needs, and may include: ETAS terms, energy technology pricing packages, automated clearinghouse data, property and casualty insurance, business interruption insurance, financial services, global secondary market pricing (used equipment), global and regional secondary market pricing (energy services), conformal contracts, revenue accounting data, customer billing and collection services, summary valuation of portfolios of energy technology projects, and best practice technical/economic data.

Some deliverables delivered by the ETAS to its clients include products that help the clients in their sales efforts, such as: financial models with analysis of project cashflows, profitability, and customer impacts reflecting the costs of all the assurance services; pricing scenarios that the client can manipulate to design a proposal or a presentation to the client's customers; a conforming service agreement (to be described below in more detail) for the equipment, which depends on the jurisdiction and other circumstances; a financial exhibit for the contract, reflecting the pricing terms; and periodic contract amendments to maintain fungibility of the site and the service agreement and compliance with newly-applied rules in that jurisdiction.

Other deliverables from ETAS that assist clients in their financial asset management include: financial models with analysis of project cashflows; portfolio accounting of all implemented projects reflecting fixed or dynamic rating as appropriate—this deliverable may be a “flat file” of general ledger entries for the client each month. Additionally, accrual and disbursement of finds for operation and maintenance activities for each contract—this might further validate service invoices and adequacy of accrual are included as deliverables in some embodiments. Optionally, certification reports for buyers or sellers for each energy technology unit under management are delivered, detailing the operating history of the unit and comparative operating data from a larger population of such units. In addition, the system may deliver appraisals of projects, units, or portfolios of owners; due diligence reports on projects, units, or portfolios for buyers and sellers; and billing for monthly services by transmitting verified “scrubbed” data to a financial automated clearing house which then bills the clients, handles box collections, and provides cash reports to client's general ledger.

Deliverables from the ETAS which can help the clients in their operation and maintenance efforts may include: cost management of construction and installation activities for each project; validation of operation and maintenance accruals for operating budgets; portfolio accounting of all implemented projects, reflecting fixed or dynamic rating as appropriate; accrual and disbursement or funds for operation and maintenance activities per contract; real-time data feed for alarm, diagnostic, and emergency notification; run status dispatch and control signalling for units via two-way data feeds to clients, utilities, or other entities; and certification and calibration reports for each unit under management, detailing the unit's operating history, optionally comparing this data to a larger population of such units. Finally, deliverables from the ETAS establish a clearinghouse for DP value elements created by standardized documents so that bids and offers can be formed into complete transactions to transfer ownership of these value elements. Fundamentally, the ETAS values existing energy technology units (DP units) based on their in-use income in either the wholesale or retail market adjusted for any barriers to achieving the full market income.

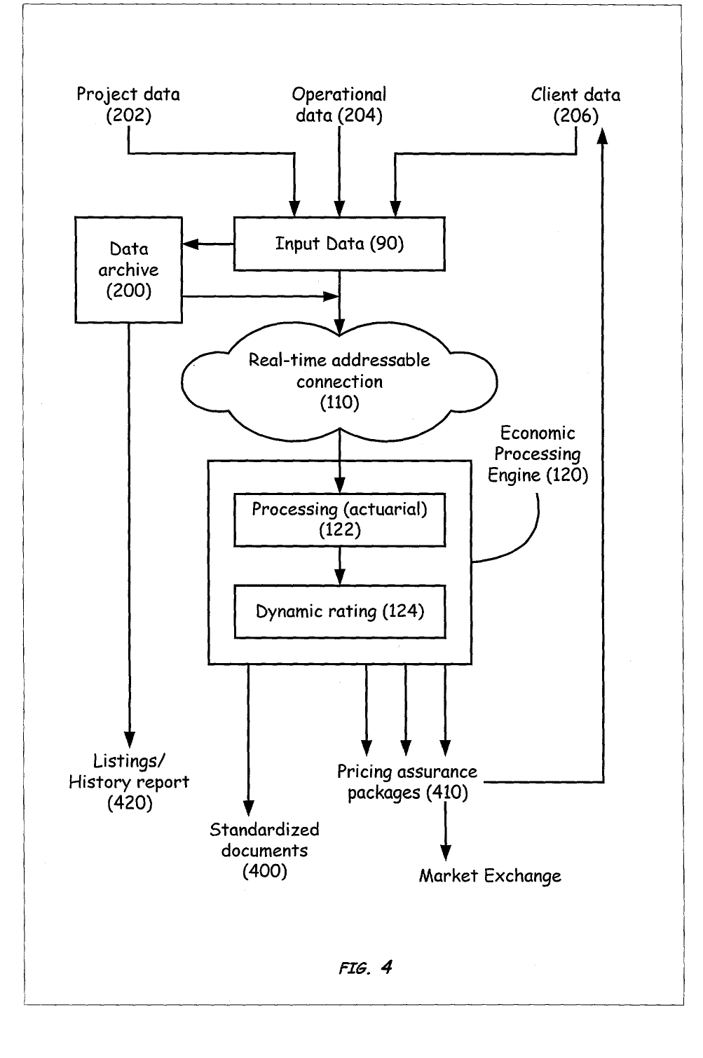

FIG. 4 depicts an embodiment of input and output parameters used by the ETAS. Input data 90, examples of which are presented in Table 1, includes archived data 200 as inputs to the economic processing engine 120 through the real-time addressable connection 110. The input data may also include project data 202, operational data 204, and client data 206 as well as other types, described in FIG. 3 above. The economic processing engine 120 may include multiple processing steps performed in the technical actuarial processor 122 and in the dynamic rating engine 124. Output results from the processing steps which will be presented to the clients 160 include conformal contracts 400 and at least one pricing assurance package 410. The pricing assurance packages 410 may then be used as future client data 206. In this embodiment, the input data 90 is also archived to data archives 200, and the archived data 200 may also be output in some other form, such as for listing or history reports 420.

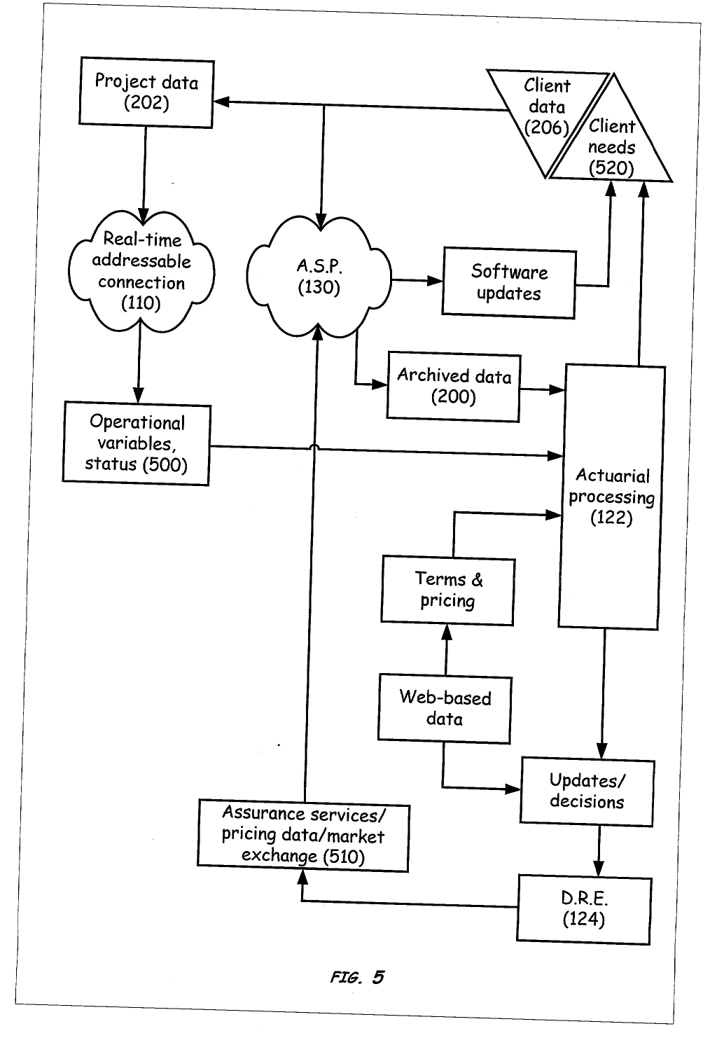

FIG. 5 illustrates yet another aspect of information flow in an ETAS system 100. The figure shows the interconnection and feedback between the input data, such as client data 206, project data 202, and other data such as operational variables and status 500, archived data 200 which are used by the actuarial processing step 122. In this embodiment the dynamic rating engine 124 outputs one or more assurance services pricing data 510 which may be presented to the client 160 depending on client needs 520 through the application service provider 130.

Some discussion of processing methods is presented below. The present description is provided for illustrative purposes, and those of skill in the art will recognize numerous ways to implement and augment and substitute techniques within the scope of the description.

The discussion above described many of the components of an ETAS system 100 and the data which can be used in its implementation. We now turn to some examples of operations carried out within the economic processing engine 120, and in particularly the technical actuarial processor 122 and the dynamic rating engine 124.

ETAS processing employs a wide range of actuarial, semi-actuarial, forecasting and modeling techniques to continually establish the price of risk management services such as value assurance and upkeep assurance and to establish and define boundaries for unique jurisdictions where standardized documents are maintained and developed.

The following is a partial list of methods which can be used in an ETAS system 100: DP project cash flow from the sale of output to the wholesale or retail energy jurisdictional market based on transactions for value elements covered by standardized documents and adjusted for economic barriers to realizing full value; DP asset life analysis including the estimation of equipment failure modes and end of life statistics using actuarial, semi-actuarial or life span; rate and accrual computations allow for various methods, procedures, techniques, and truncation including straight-line and sinking fund, vintage group, ELG or broad group, remaining life or life cycle (whole life), life span or full mortality; utility theory as the rationale for assurance; mortality investigations; the effect of the variation of assumptions; levelized financing of increasing risk; reserve restructuring; theoretical reserve analysis; true cost accounting; accrual rates; reserve adequacy and net salvage monitoring; alternative asset valuation; accrual calculations include valuation rates and theoretical reserves for individual unit categories; recorded reserves allocated to vintages; average net salvage rates computed as required by client' regulators.

Accrual and valuation procedures support most depreciation systems, including composite systems in which an age distribution is divided into multiple time periods and different procedures are applied over each period. Life Analysis can also be used to estimate the dispersion and average service life of a unit category.

Actuarial methods including hazard or survival functions are also employed, as well as band selection and use of Iowa, Gompertz or H-curves and others.

Semi-actuarial methods include simulated unit record analysis and computed mortality; current leveling, loss development and trending, and the determination of expense provision; classical, Bayesian and Bahlmann models for credibility including best linear unbiased estimates.

As for the outputs of the ETAS system 100, these may take the form of pricing options as illustrated in the following discussion of ETAS products available to the ETAS clients. Examples of products available to ETAS clients include: conforming contracts and secondary market pricing for technology units and energy services. The following discussion explains in more detail the features and advantages of these products in the DP marketplace. These pricing options can also be reflected in reduced interest rates from lenders to project operators employing the services of a project value assurance or ETAS provider.

The expense of negotiating and executing agreements in the energy market is too high to allow for small-scale projects to effectively benefit from careful agreement structuring, especially given the number of energy jurisdictions which complicate the drafting of proper documents. This discourages deal-making by utilities and DP project operators. Value can be extracted from DP projects, by selling their power output, if the terms of contracts in the thousands of jurisdictions where DP is deployed can be standardized and streamlined among sales channels. These sales channels add or subtract value by defining unique contract structures. An entity with a broad, channel neutral, technology neutral focus could create jurisdictional knowledge and standardized contract terms that could be shared. These shared contract terms would become the basis for standardized “conforming contracts” for the value elements the DP market that would resemble the conforming mortgage in the home lending market (site, improvements (DP system), upkeep).

With standardized documents for upkeep service and sites in place, the sales channel could quantify and, if desired, monetize the value created. These steps would lead to greater choice and lower pricing for end use customers and, in turn, greater sales for the channels and manufacturers of DP units. Finally, conforming contracts would dramatically reduce transaction costs for buyers in the secondary market while increasing the value an owner could realize in a sale or transfer.

Shifting risk and monetizing value requires robust secondary markets. In order to value DP based on in-use value, three secondary markets are needed: equipment, upkeep agreements, and site contracts. While a used equipment market has always existed, with some rare exceptions DP units for sale typically lack traceability of upkeep and certification of condition. In the case of upkeep agreements and site contracts, buyers are emerging, but their transaction costs are too high. Adoption of standardized documents can reduce transaction costs to an acceptable level.

There exists a worldwide secondary equipment market, which can be exploited more effectively using various aspects of the invention. DP equipment is characterized by relatively low obsolescence. If properly maintained, a DP unit holds a greater portion of its value than accounting conventions usually reflect.

If an entity had a system that archived the unit operating data captured for a variety of purposes and tracked upkeep history, it could offer dynamically priced value assurance to sales channels, or potential DP site operators who were considering installation, purchase, or had previously purchased equipment. The sales channel or consumer could continue its accounting treatment of the DP asset, but provider would create a “synthetic unit of production depreciation schedule” that would reduce costs to the end consumer of electric power.

These same data would strengthen the value of used equipment so the consumer could be offered liquidity, that is much shorter lengths of commitment or ownership. This system would also enable the same entity to offer attractively priced extended warranties on DP units that would relieve manufacturers or their sales channels of covering such risks in their accounting. While a manufacturer or its channels could underwrite such risks, the small market base and lack of real time data and a means to dynamically price such risk would result in “above market” costs to end users.

In addition to a secondary market for DP equipment and hardware, a secondary market for site contracts and upkeep agreements can be created. This can be brought to bear on the problem of financing and operating DP projects, which are not only influenced by the initial value (purchase price) but also by the residual value present in the equipment and the value of the project's presence and lease rights for example. The risk of insuring the projects has been high because the traditional methodology used by insurers to guarantee an outcome, part of which is their approach to residual value determination. The insured has paid excessive rates, which further detracts from the economic value of the project.

Value improvement may be realized when (and if) the equipment is transferred after its initial service. However, by coupling value assurance with standardized site contracts and upkeep agreements, a mechanism for “virtual movement” is created so that a fuller value of previously installed DP units can be quantified and monetized.

The data that is captured from DP projects will support existing secondary markets, such as used equipment dealers, by identifying certified DP units that may have higher than average value in the secondary market. At the same time, a stronger secondary market for equipment can be expected to stimulate additional equipment sales at the manufacturer and sales channel levels. This same integrated scheme of data capture, analysis and transfer enables the creation of new secondary markets for upkeep agreements and site contracts. By linking technologies that exist to manage dispersed command and control with electronic market exchanges it is possible to produce a cost effective, real time, dynamic means of providing risk management services.

An Illustrative Example of Valuation of a Distributed Power System

In one aspect, current and future values of an energy technology (e.g., a distributed power system) are determined to set a residual value of the system. Taken in the context of FIGS. 1-6, a number of input variables and parameters are collected, as in act 20 of FIG. 1, from various input data sources 90, as in FIG. 3. These input data are then used to calculate a value V of an energy technology service or system, as in act 30 of FIG. 1. The calculations, given below for illustrative purposes only, may be performed in the Economic Processing Engine 120, as in FIGS. 2 and 3. Finally, results of the calculation can be presented to a client or user 160 as in act 40 of FIG. 1. To determine the value (V) of a system at any time (t), the factors that must be considered take the form of the following equation:

Vₜ=k₁R+k₂e+k₃v+k₄m+k₅E+k₆F+k₇Lₚ (Eq. 1)

And:

E=f(k₈w,k₉u) (Eq. 2)

F=Σ(kᵢxᵢ+kⱼdⱼ₎ₙ (Eq. 3)

Where:

kₓ=Coefficients for the valuation assessment

R=The physical remaining life of the system.

e=The fuel conversion efficiency and versatility of the system at time (t).

v=The emissions and discharge performance of the system

m=The expected upkeep costs over the remaining life R

E=The delivered cost of electricity where:

w=The wholesale price of electricity in the region

u=The transmission, distribution, social benefit, deregulation transition charges, and other utility fees, tariffs, etc.

F=The total cost of fuel(s) for the system delivered to the site where:

xᵢ=The wholesale price of n fuels in the region that the system can use

dⱼ=The delivery and storage costs for each of j fuels including transmission,

distribution, and other local distribution company fees, tariffs, etc.,

for natural gas plus fully allocated site-related storage costs including

permitting and compliance for each fuel stored on site.

Lₚ=The limits of the system's operating under its interconnection agreement with the local utility and/or ISO and its applicable emission and discharge permits.

Combining and expanding Eq. 1 through Eq. 4 we have:

Vₜ=k₁R+k₂e+k₃v+k₄m+k₅f(k₈w,k₉u)+k₆Σ(kᵢxᵢ+kⱼdⱼ₎ₙ+k₇Lₚ (Eq. 4)

Examining Eq. 4, the terms fall into four groups for describing the value of a distributed power system at time t:

(1) the expected physical attributes, performance, and condition of equipment,

(2) the locality of the site, or “jurisdiction” value,

(3) the regional/national energy commodities markets (electricity, natural gas, liquid fuels), and

(4) the environmental characteristics of the system equipment value element.

The first four terms in Eq. 4 are the remaining useful life (R), efficiency (e), emissions (v), and expected upkeep costs (m), are related to the equipment value element. However, v is also related to the environmental value element. Valuation assessment considers expected future performance or requirements. In all of the DP project valuations analyzed, we have noted that ki for these terms are considered to be zero by lenders, underwriters, providers, and the end users. Since today's valuations entirely discount the equipment value elements, the cost of the project financing is increased dramatically or perhaps made entirely infeasible. This is like leasing a $30,000 car according to terms that assume a zero value after 36 months, whereas the car actually is worth $18,000 at that point. The lessee pays for $30,000 decline in value instead of $12,000 decline. Not a very good deal, to be sure. In the extreme, these near-zero coefficients imply that the equipment is worthless the day it is installed and has no future value. In other words, end users will be stuck with useless assets. Of course, such assumptions are erroneous.

Experts have estimated that there are 30,000 to 50,000 jurisdictions for distributed power in the U.S. However, in the case of the core market where project finance is jurisdictionally specific, a smaller set of sufficient jurisdictions can be addressed.

In many jurisdictions, additional environmental and operating factors are jurisdictionally influenced. For example, the enforcement methods in a jurisdiction may alter the coefficients for emissions performance v and operating characteristics under environmental permits and interconnection operating agreements in Lₚ.

There are two terms in Eq. 4 related to value defined by ajurisdictional value element. Delivery costs of grid-supplied electricity (u) and the delivery and storage cost of fuels (dⱼ). Each of the components of a jurisdictional value element is subject to the combined effect of two coefficients. These two coefficients may be less than unity, so the resulting combination is a smaller number.

Fuel-related costs dⱼ are unique for each of j fuels. Natural gas transmission and LDC costs (typically, gas transportation rates) reflect load factor considerations for DG and the gas system. DG systems that present a natural gas load factor that is more favorable than the load factor for the LDC system may receive incentive rates. Delivery costs are also factored into the valuation as are storage costs for liquid fuels. These rates vary by jurisdiction that may not map to the electrical costs u. This factor generates some of the jurisdictional complexity.

Two terms in Eq. 4 are related to energy commodity markets, the wholesale electricity w and fuel costs xᵢ and reflect the regional and national markets for energy commodities.

The environmental benefits element term expresses the value of low emissions, high efficiency generators in the locality.

Residual Value Enhancement and Assurance

The discussion below relates to the residual value, and the assurance of residual value of DP projects, according to some aspects of the present invention.

In many cases it is desirable to maximize the economic benefit and value of a multi-component distributed power project at the termination of the project as well as during its lifetime. For this to occur, residual value in the project and in the components constituting the project should preferably be maximized. Residual value may be obtained (i.e., converted to cash or another asset) from a project or components thereof through transfer of the project or the components to another new owner. The term “owner” is used broadly herein, and is meant to encompass more than mere recipients of title through some form of conveyance. An owner may also be a lessor or other operator who substantially controls the project or the asset.

Residual value of a project is maximized through minimizing the loss of value (over time) of assets associated with the project. Collectively, the loss of value of such assets will lead to the overall loss of value to the project. For a given amount of usage, operating and maintenance practices designed to minimize equipment breakdown and to maximize its operating efficiency also minimize the decline in value, which factors into the residual value of the equipment at any point in its life, including at the end of its useful life. Thereafter, the equipment may be traded or salvaged. Assets which are not salvaged or sold or transferred to new owners may still retain residual value even if such value is the scrap value of the assets. For example, the assets may be transferred to recycling facilities or other facilities which can extract value from the assets even though they are not usable for the purpose for which they were originally designed.

The concept of useful life, and the related concept of remaining useful life, are briefly explained. Useful life of an asset or a project is determined as the time its true overall economic value falls below some threshold, at which point the asset or project can be considered to no longer be productive. Often, the overall economic value and remaining useful life are determined largely by one or more components of a multi-component distributed power project. Indeed, the remaining useful life may be determined by the life of the longest-lasting major component in the project, or may be determined by the lifetime expected for an irreplaceable component in the project. Thus, the useful life of a project be determined by the useful life of its most costly component(s), which cannot be economically substituted or replaced at the end of its life (or their lives). In some projects, this component will be the photovoltaic units; in other projects, this component might be the turbines; and yet in other projects, this component may be an intangible attribute such as a contractual or lease provision.

The Market exchange is primarily concerned with deals relating to the DP project site and equipment that are covered by the assurance contracts and residual value assurance services. This is analogous in some ways to a “multiple listing service (MLS)” in real estate, but for project owners, informing potential buyers that a system is covered by an assurance contract and documented as such. Projects are automatically included in generic summary listings of total capacity behind certain electric control areas or utilities. If a project owner wishes to test the market, the owner can acquire a listing. The assurance provider may also accepts bids or inquiries from potential new buyers (or users). This may be done over a network, e.g., the Internet, using an ASP, or through an alliance or aggregation of similar exchanges.

Note that value may be added to a project by its mere presence on a grid, or by its having “squatter's rights” in a valuable part of the power grid. If the operator of a DP project has exclusive rights to operate, sell, or deal in power on a valuable power grid, this exclusivity and other contractual rights associated with being connected to the grid have value in themselves. It should be noted however that economic considerations such as disposal fees, transactional costs and other costs associated with termination or transfer of a project need to be subtracted from the otherwise-determined residual value of the project if such costs necessarily accrue at the termination of the project.

The process of mitigating economic risk can be integrated into the overall pricing option determination as an extension. The upkeep assurance and data monitoring, valuation of assets, standardized documents and market exchange provide an integrated means for reducing risks from underwriting the project and its assets.

The market value of an asset that is consumed or worn out through usage, and thus its perceived residual value, is influenced both by the actual condition of the asset at any time and by the uncertainty involved in determining that condition. Consider two otherwise identical used cars. The owner of one of the cars kept careful maintenance records and the car was maintained on a regular schedule by a certified mechanic. The owner of the other car kept no records. Assuming both owners are strangers to a buyer, the buyer would naturally be willing to pay a higher price for the first car. Thus, diligent maintenance can lengthen the useful life of a project.

Accordingly, one aspect to consider is the ability to monitor and assure a transferee that elements of a project have been properly maintained and operated to maximize their useful lives and residual values. The present invention provides for residual value assurance in a project or components thereof through monitoring and collection of historical and operating data relating to the project and/or components thereof. These data are then archived and analyzed to adjust maintenance schedules and to help predict future performance and expected remaining life.

Knowledge of the maintenance and historical usage and operating conditions for an asset can be used then to reduce the cost of insurance and assurance services for lenders and other entities which carry the risk associated with future operation of the equipment or the project. If institutions granting loans for DP unit purchasing or operation are able to remove some of the risk in predicting useful life and residual value of the project, then such institutions will be able to reduce the borrowing cost to the project operators; and they may be able to offer a higher loan-to-value ratio. Such risk reduction can be achieved by requiring the project operator to maintain project components in accordance with manufacturer or third-party recommendations. Monitoring maintenance and upkeep practices can be implemented, optionally through instrumenting the machines and recording maintenance and operation logs to ensure compliance. An administering service provider or the lender may step in to take over the maintenance in the event of a performance default.

A third-party energy technology assurance provider (such as the aforesaid administering service provider) may be engaged by one or both the operator and the lender. The assurance provider monitors project usage and maintenance and exercises the lender's “step-in” rights to perform maintenance when the project operator fails to do so.

Some of the resulting costs saving (e.g., interest rate reduction) may be passed on to the energy technology assurance provider as a fee. Optionally, but preferably, funds are set aside for upkeep (e.g., from each loan payment) and escrowed in an escrow account set up for this purpose. The escrowed upkeep monies may move with the project if the project is transferred. The assurance services provider may be the escrow agent.

In addition to producing outputs useful for calculating pricing options, various aspects and embodiments may be used for mitigating economic risk. It should be clear that some or all of the aspects described previously can be used to better predict residual value calculations and thus can be used to mitigate the economic risks associated with financing, operating or otherwise assuring an energy technology project or upkeep associated with the project. Such mitigation of economic risk can translate in some embodiments into increased profits for operators and reduced costs for customers.

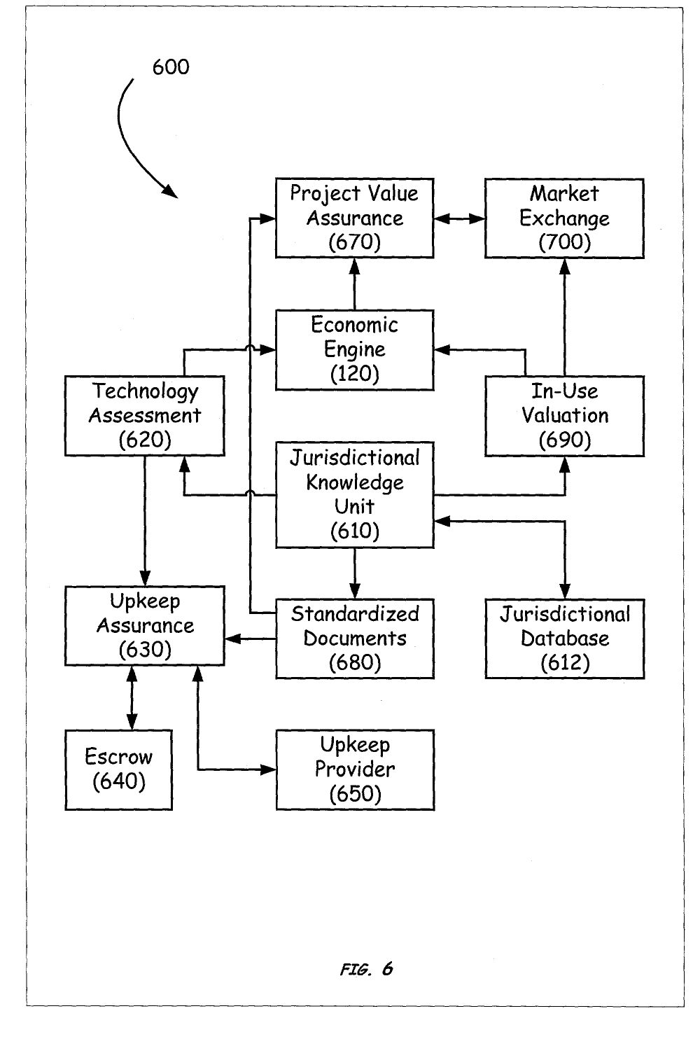

The project value assurance system is illustrated at FIG. 6. The system 600 comprises various components which exchange information, taking inputs and providing outputs to one another and to and from clients and energy technology (DP project) components. FIG. 6 is meant as an illustrative exemplary embodiment, and many other configurations and arrangements of the components shown therein are possible. Furthermore, numerous other auxiliary functions and subsystems are possible to add functionality to the overall system 600.

Shown in FIG. 6 is a jurisdictional knowledge unit 610, which has primary responsibility for maintaining and analyzing information related to, jurisdictional aspects of a distributed power project. There may exist a large number of statutory, regulatory and other considerations relating to the jurisdiction in which the distributed power project operates. A complete or incomplete set of jurisdictional factors and parameters may be used with the present system. Specifically, Table 3 provides an exemplary list of typical jurisdictional knowledge parameters, for purposes of illustration, some or all of which may be maintained by jurisdictional knowledge unit 610.

The jurisdictional knowledge unit 610 may include or be coupled to a dedicated jurisdictional database 612, or may be coupled to a general purpose database which is shared with other modules of the system. These databases, which contain the relevant jurisdictional knowledge parameters, can be dynamic and updated according to changes in rules affecting distributed power projects and contracts.

The jurisdictional knowledge unit 610 may be involved in assisting operators or executing algorithms to test hypothetical scenarios of jurisdictional rules, statutes and regulations that can change the outcome and the economic behavior of models used in the system. Expert “pilots”, who might be persons with experience in this field, could augment the jurisdictional knowledge unit 610 or provide input parameters and test scenarios for the system. The jurisdictional knowledge unit 610 provides terms and conditions of transferability to the standardized documents unit 680. The jurisdictional knowledge unit 610 may also provide and maintain knowledge relating to tax rates and net metering rates in a particular jurisdiction, for example.

An in-use valuation unit 690 is used for receiving scenarios possible under the jurisdictional knowledge framework, and contribute to the anticipation capability of the system 600 by predicting trends and changes in both technology (in cooperation with the technology assessment unit 620) and the jurisdictional knowledge unit 610. Legal and technological developments are used, as they impact the future use and value of the overall project.

The operational data and the historical data, as well as any other data, such as jurisdictional data, are used as inputs in a model for performing calculations. Typically, the input parameters and data collected from the operational, historical and jurisdictional data inputs, are used as numerical parameters or can be used as indicators corresponding to numerical parameters for a mathematical model. A detailed description of statistical actuarial models are described elsewhere in this application and in other references known to those skilled in the art. Well-known models, as well as new models for performing the calculations, may be employed. The models may have a predictive value which can better predict residual value of components or entire DP projects, as well as predict remaining useful life and assurance service pricing options therefrom.

A pricing option or a plurality of pricing options presented in a package may be calculated from the model as described above. In some embodiments, the residual value of a component of a multi-component DP project, or the residual value of the entire project, is calculated using the models. Additionally, a pricing option for an individual service or combination of services may also be calculated in this way. For example, value assurance services and maintenance contracts and insurance policies may be priced accordingly.

Various elements of the system and units described above are implemented in software running on computers. In some embodiments, each unit, e.g., the jurisdictional knowledge 610, is implemented as a separate subroutine or program. The various units may take and pass information from one to the other as required to obtain the desired results. For example, output from the jurisdictional knowledge unit 610 may be passed as numerical or logical data to the input of the project value assurance unit 670. The discussion below briefly describes exemplary aspects of computerized technology suitable for carrying out various aspects of the invention.

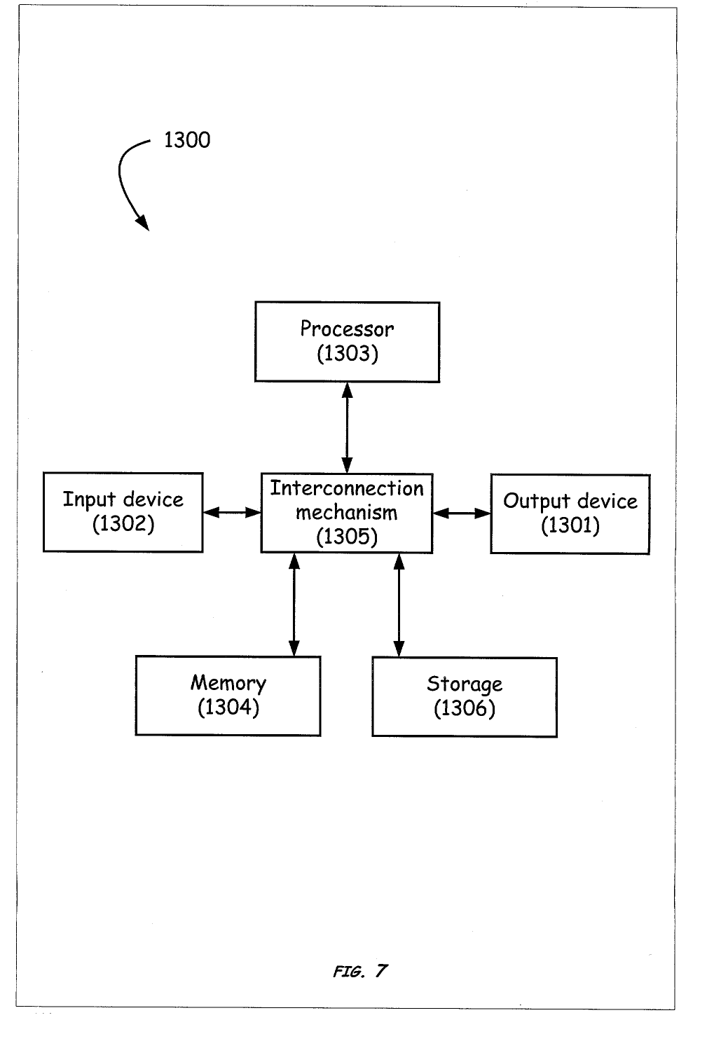

In some embodiments, aspects and portions of the present invention are implemented on a data processing system or on a computer system; an example of such a computer system 1300, is shown in FIG. 7. Various elements of the embodiments described herein, either individually or in combination, may be implemented on the computer system 1300. Typically the computer system 1300 includes at least one central processor unit coupled, directly or indirectly, to one or more output devices 1301 which transmit information or display information to one or more users or machines (not shown). The computer system 1300 is also coupled, directly or indirectly, to one or more input devices 1302 which receive input from one or more users or machines. The system may include one or more processors 1303 coupled, directly or indirectly, to a memory system 1304 via one or more interconnection mechanisms 1305, examples of which include one or more buses and/or switches. The input devices 1302 and the output devices 1301 are also coupled to the processor 1303 and to the memory system 1304 via the interconnection mechanism 1305. The computer system 1300 may further comprise a storage system 1306 in which information is held on or in a non-volatile medium. The medium may be fixed in the system or may be removable or partly fixed, partly removable.

The computer system 1300 may be a general purpose computer system which is programmable using a computer programming language. Computer programming languages suitable for implementing such a system include at least procedural programming languages, object-oriented programming languages, and macro languages, or combinations thereof. The computer system 1300 may also be specially-programmed, special-purpose hardware, or one or more an application-specific integrated circuits (ASICs), or some combination thereof.

In a general-purpose computer system, the processor 1303 is typically a commercially-available processor which executes a program called an operating system (OS). The OS, in turn, controls the execution of other computer programs and provides scheduling, input/output and other device control, accounting, compilation, storage assignment, data management, memory management, communication and data flow control and other services. The processor and operating system define the computer platform for which application programs in other computer programming languages are written. The invention is not limited to any particular processor, operating system or programming language.

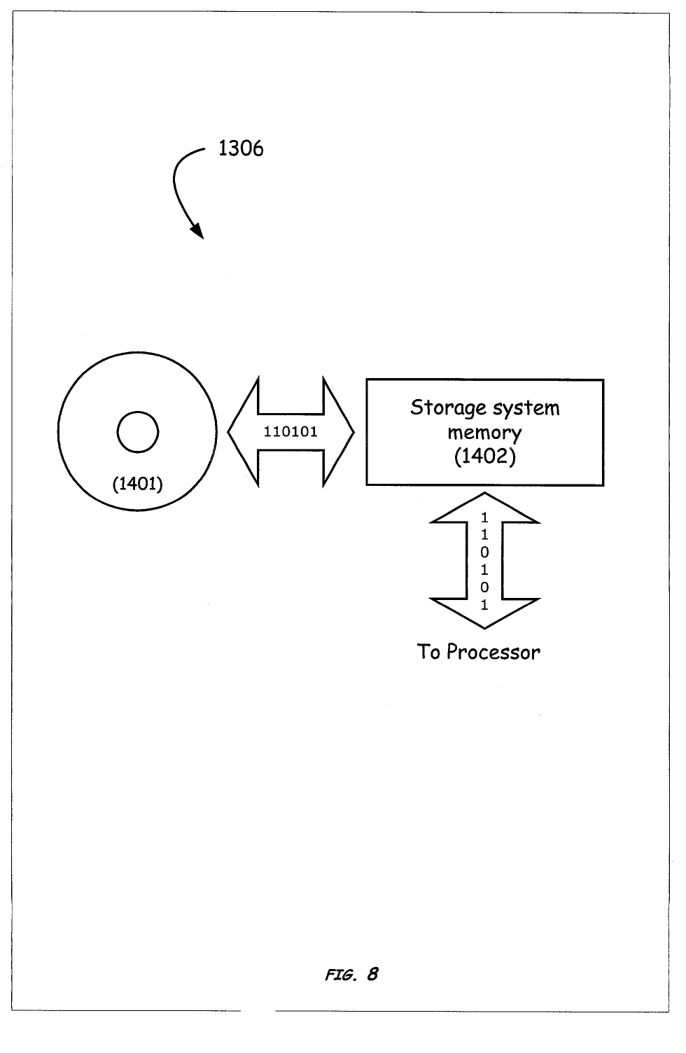

The storage system 1306, shown in greater detail in FIG. 8, typically includes a computer-readable and writeable nonvolatile recording medium 1401 in which signals or instructions are stored that define a program to be executed by the processor 1303 and/or information to be used by the program. The medium 1401 may, for example, be a disk or semiconductor memory or some other form of data storage. Typically, in operation, the processor 1303 causes data to be read from the nonvolatile recording medium 1401 into another memory 1402 that allows for faster access to the information by the processor 1303 than does the medium 1401. This memory 1402 is typically a volatile, random access memory (RAM), such as a dynamic random access memory (DRAM) or static random access memory (SRAM). It may be located in storage system 1306 or in memory system 1304. The processor 1303 generally manipulates the data within the storage system 1306 and/or memory 1304 and then copies the data to the storage system 1306 and/or memory 1304 after processing is completed. A variety of mechanisms are known for managing data movement between the medium 1401 and the memory element 1304, 1402, and the invention is not limited thereto. The invention is also not limited to a particular memory system 1304 or storage system 1306.

Operational data is generally defined as information and signals collected from equipment and elements of a DP project during their lifetime and most likely during their operation. Operational data is not strictly limited to data obtained from measurement and instrumentation attached to operating equipment, but can include data obtained from patterns of operation of the equipment and environmental conditions in which the equipment operates. As mentioned elsewhere, operational data can include data relating to operating parameters such as revolutions per minute (RPM), oil temperatures, steam pressures, loads, voltages and currents in electrical equipment, alarm conditions, and any other aspects of equipment operation which can impact its remaining useful life or its need for service or repair. Other data can include environmental data such as ambient temperatures, humidity conditions, salinity and viscosity of operating fluids, structural vibration data, etc. In addition, equipment cycling and duty cycle information may be used. This includes logs reflecting the time and number of start and stop cycles, as well as information related to the ratio of on-time to off-time by which the equipment is operated.

Historical data is data which is generally not collected in real-time, but rather is obtained from historical or archive sources. Generally, historical data is obtained from databases or other repositories of stored data. Preferably, this historical data can be accessed over a communication network, such as the Internet. Many other communication channels may be used to obtain historical data, for example, over telephone lines, wireless connections, optical connections, or any other channel or medium suitable for carrying such data.

Historical data may include data archived in an archive 200 and kept by an equipment manufacturer or a service provider. For example, an entity performing maintenance on a particular type of equipment may log and retain data relating to breakdown of the equipment and weaknesses and strong points known to be associated with the equipment.

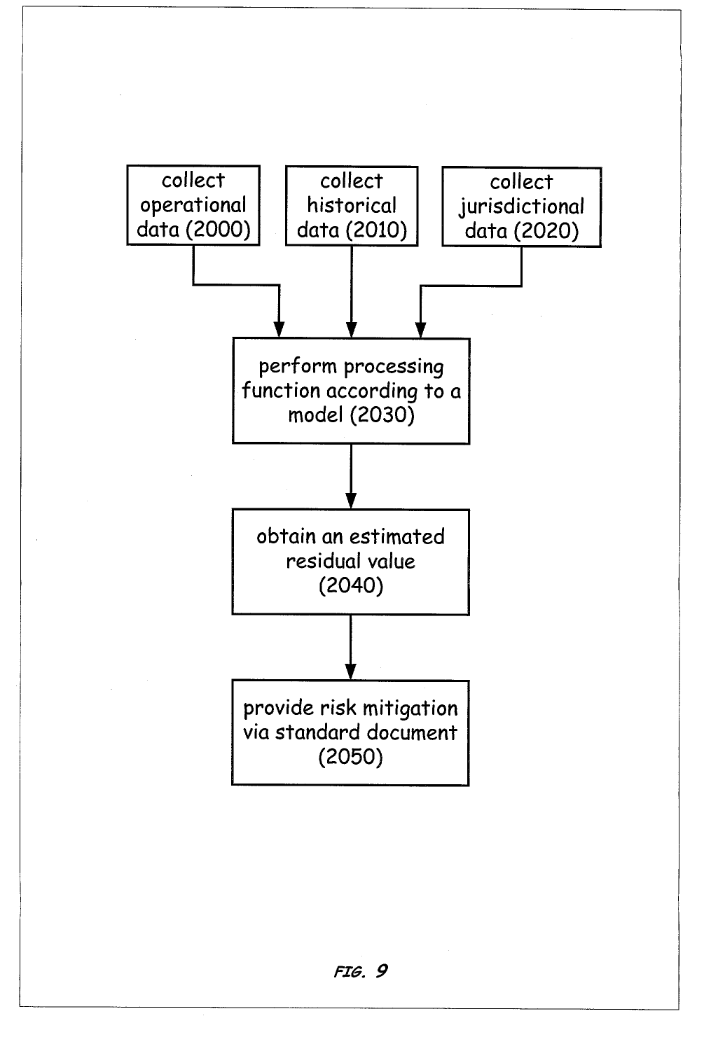

FIG. 9 illustrates the outline of a process according to one embodiment in which data is collected to perform a processing function and provide useful output relating to residual value and risk. In acts 2000-2020, operational, historical and jurisdictional data is collected, respectively. In act 2030, a processing function is performed according to a model, examples of which are described above. In act 2040, an estimate of the residual value of a component or a project is obtained from the model. Then, in act 2050, economic risk associated with underwriting or operating or insuring the project or components thereof is provided. This mitigation of risk can come in the form of a standardized document incorporating the results of the residual value estimation. If said residual values are estimated more accurately as described herein, then a lower insurance or underwriting cost can be achieved with the same degree of confidence as in traditional underwriting methods.

TABLE 1
Exemplary Data Inputs for ETAS.

| | Key: | | |
|---|---|---|---|
| Categories | Code | Description | Terms |
| Project (at a | CS | Client Support | ASP = input from web by |
| customer) | | | client or customer service |
| | | | telcon |
| Client (a type of | JK | Conforming Site | Form = data entry form |
| Organization, see | | Contract | (electronic or paper) |
| below) | | | |
| Contact (an | SK | Conforming Service | Lookup = converts one field |
| individual) | | Agreement | to another |
| Customer (a client's | VA | Value Assurance | Menu = Table of choices |
| customer) | | | |
| Jurisdiction | OA | O & M Assurance | Outreach = Personal contact |
| | | | or research |
| Network | IM | Information | Profile = Internally |
| | | Management | generated setup data |
| | | (Portfolio | |
| | | Accounting, Billing, | |
| | | Operations) | |
| Organization | FS | Financing Services | RT = input from unit via |
| (various types) | | | network polled for real time |
| | | | basis. Integrated over time |
| Product/Unit (DP | P-T | Professional | Verify = monitor or check of |
| equipment) | | Services/Market | data against baselines or |
| | | Transactions | other standards. |
| | | | Data Uses by |
| Category | Example Source | Data Type | Product |
| Client | Profile, Service | Service Agreement data | CS, JK, SK, VA, OA, |
| | Agreement | (various records) includes | IM, FS, P-T |
| | | prospects not yet signed | |
| Client | Profile (menu) | Business model type | CS, JK, SK, VA, OA, |
| | | (multiple choices possible | IM, FS, P-T |
| | | per client) | |
| Client | Profile, Login, ID | Client Firm Name (parent | CS, JK, SK, VA, OA, |
| | | and satellite) | IM, FS, P-T |
| Client | Profile | Address, City, State | CS, IM, FS |
| Client | Profile, Login, ID | Client Contact Auth Level | CS, JK, SK, IM |
| Client | Profile, Login, ID | Accounting policies | CS, IM, FS |
| | | (various) | |
| Contact | Outreach | Contact Name (and various | CS, JK, SK, IM |
| | | associated records and links) | |
| Contact | Profile (menu) | Organization - Contact Link | CS, JK, SK, VA, OA, |
| | | | IM, FS, P-T |
| Customer | ASP, form | Customer Name | CS, JK, SK, VA, OA, |
| | | | IM, FS |
| Customer | Assigned (unique) | Code | CS, JK, SK, VA, OA, |
| | | | IM, FS |
| Customer | ASP, form | Cust Address, City, ST | CS, IM, FS |
| Customer | ASP, form | Cust Billing Address | IM |
| Customer | Rating Services | Credit Rating | FS |
| Jurisdiction | Code (lookup) | Internal setting | CS |
| Jurisdiction | (lookup) | EPA region | JK, SK, VA, OA, FS |
| Jurisdiction | (lookup) | State environmental district | JK, SK, VA, OA, FS |
| Jurisdiction | (lookup) | State/local code enforcement | |
| | | Multiple fields likely for | |
| | | various tasks | |
| Jurisdiction | (lookup) | State/local approval district | CS, JK, SK |
| Jurisdiction | Profile, Data | Key word indexed library of | CS, JK, SK, OA, P-T |
| | Sources | utility tariffs, environmental, | |
| | (continually | tax and other regulations | |
| | updated) | cross referenced to contracts | |
| Jurisdiction | Library, Archive | Library of conforming | CS, JK, SK, OA, P-T |
| | | contracts, contract terms, | |
| | | current effective, history and | |
| | | proposed amendments cross | |
| | | referenced to regs. | |
| Jurisdiction | Published Data | Prevailing wage district | SK, VA, OA, IM, P- |
| | | | T |
| Network | Profile, ASP | Protocol and network(s) | CS, VA, OA, IM, P- |
| | (menu) | used for communication | T |
| Upkeep | Work tickets, | Various information on | SK, VA, OA, IM, P- |
| Providers | invoices for | work performed on units, | T |
| | services | billing, unplanned service | |
| | performed | calls. Verification | |
| Organization | Outreach | Organization Name (parent | CS, JK, SK, VA, OA, |
| | | and satellite) | IM, FS, P-T |
| Organization | Menu | Type: Client, manufacturer | |
| | | consultant, EPC | |
| Organization | Outreach | Address, City, State, Zip | CS, JK, SK, VA, OA, |
| | | (for each location) | IM, FS, P-T |
| Organization | Outreach, Profile | Various names and | CS, JK, SK, VA, OA, |
| Suppliers | | associated type, contacts and | IM, FS, P-T |
| | | etc. with agreement data | |
| | | regarding services offered | |
| Organization: | Organization | Various information on | OA, IM |
| Service | Source, Profile | sites, contacts, HQ services, | |
| providers | | etc., certifications, web | |
| (e.g., EPC, | | links, etc., geographic area | |
| A & E, | | served. Web link for clients | |
| controls) | | | |
| Organization: | Outreach, Profile | Various names and | CS, JK, SK, IM, FS, |
| Allies | | associated type, contacts and | P-T |
| | | product data etc. with | |
| | | agreement data regarding | |
| | | offered | |
| Organization: | Organization | Various information on | JK, SK, VA, OA, IM, |
| Upkeep | Source, Profile | sites, contacts, HQ services, | FS |
| Providers | | etc., certifications, web | |
| | | links, etc., geographic area | |
| | | served | |
| Organization: | Outreach, | Various names and | SK, VA, OA, FS, P- |
| Manufacturers | Profile | associated type, contacts and | T |
| and | | product data | |
| integrators | | | |
| Product/Unit | Organization | Various product technical | CS, JK, SK, VA, OA, |
| | Source, Profile | specifications (current and | IM, FS, P-T |
| | | historical products) and | |
| | | other data via web for use | |
| | | internally or link to clients | |
| | | (also for internal use: | |
| | | clients' products) | |
| Project | ASP, form | Customer-Project Link | CS, JK, SK, VA, OA, |
| | | | IM, FS |
| Project | ASP, form, | ID number (client's and | |
| | unique | internal) | |
| Project | ASP, form | Offering type: equipment | CS, JK, SK, VA, OA, |
| | (menu) | sale, development, energy | IM, FS, P-T |
| | | sale, chauffage, etc. | |
| Project | ASP, form | Proj Street Addr. | JK, SK, VA, OA, IM, |
| | | | FS, P-T |
| Project | ASP, form | Proj City | JK, SK, VA, OA, IM, |
| | | | FS, P-T |
| Project | ASP, form | Proj State | JK, SK, VA, OA, IM, |
| | (lookup) | | FS, P-T |
| Project | ASP, form | Project Zip code | JK, SK, VA, OA, IM, |
| | (lookup) | | FS, P-T |
| Project | ASP, form | Jurisdiction Project Link | JK, SK, VA, OA, IM, |
| | (lookup) | | FS, P-T |
| Project | ASP, form | Total Capacity (kW) | JK, VA, OA, IM, P-T |
| Project | ASP, form | Number of Units | CS, SK, VA, OA, IM, |
| | | | FS, P-T |
| Project | ASP, form | Unit Mfgr and Model (ea) | CS, SK, VA, OA, IM, |
| | | | FS, P-T |
| Project | ASP, form (menu) | Project type - e.g. storage, | JK, SK, VA, OA, IM, |
| | | gen, grid conn., grid indep, | FS, P-T |
| | | grid bu. | |
| Project | ASP, form (menu) | Primary fuel type | JK, SK, VA, OA, IM, |
| | | | FS, P-T |
| Project | ASP, form | Primary fuel storage or | CS, JK, SK |
| | | delivery, metering etc. | |
| | | (several variables) | |
| Project | ASP, form (menu) | Switchgear (various items) | CS, JK, SK, VA |
| Project | ASP, form | Primary fuel distrib. | JK, SK |
| Project | ASP, form (menu) | Secondary fuel type | JK, SK |
| Project | ASP, form | Secondary fuel storage or | CS, JK, SK |
| | | delivery (several variables) | |
| Project | ASP, form | Secondary fuel distrib. | JK, SK |
| Project | ASP, form (menu) | Unit category e.g., prime, | JK, SK, VA, OA, IM |
| | | standby, etc. | |
| Project | (lookup) | Tax district local, state | JK, SK, VA, IM, FS, |
| | | | P-T |
| Project | (lookup) | Electric utility branch, feeder, | JK, SK, VA, IM, FS, |
| | | substation and delivery point | P-T |
| Project | (lookup) | Natural gas, main, gate | JK, SK, VA, IM, FS, |
| | | station, transmission line | P-T |
| Project | ASP, form | Upkeep provider Link | SK, VA, OA, IM |
| Project | ASP, form | Cost breakdown (assets and | CS, JK, SK, VA, |
| | | operating costs) | OA, IM, FS, P-T |
| Project | ASP, form | Customer pricing | CS, JK, SK, VA, |
| | | | OA, IM, FS, P-T |
| Project | ASP, form | Phase or Status | CS, JK, SK, VA, |
| | (menu) | | OA, IM, FS, P-T |
| Project | ASP, form | Upkeep selection optional | CS, JK, SK, VA, |
| | (menu) | services to be provided and | OA, IM, FS, P-T |
| | | alternatives presented | |
| Project | Secondary market | Bid/asked pricing on | CS, JK, VA, FS, P-T |
| | for site contracts | locational project portfolios | |
| Project | Secondary market | Bid/asked pricing on | CS, SK, OA, FS, P-T |
| | for upkeep | locational project portfolios | |
| | contracts | | |
| Unit | Profile, ASP | Nameplate data | CS, JK, SK, VA, |
| | | | OA, IM, FS, P-T |
| Unit | Scanned Image | Commercial filings | CS, JK, SK, VA, |
| | | | OA, IM, FS, P-T |
| Unit | RT | Ambient Temperature | CS, VA, OA, IM, P- |
| | | | T |
| Unit | RT | Fuel meters: | CS, VA, OA, IM, P- |
| | | reading/type/levels/pressures/ | T |
| | | temp./BTU content | |
| Unit | RT | Exhaust and cooling temps | CS, VA, OA, IM, P- |
| | | | T |
| Unit | RT | Status | CS, VA, OA, IM, P-T |
| Unit | RT | Transducer readings (lube | CS, VA, OA, IM, P-T |
| | | temp, lube pressure, cooling | |
| | | auxiliaries status and other | |
| | | diagnostic readouts) | |
| Unit | RT | Converted energy output | CS, VA, OA, IM, P-T |
| | | kWh and kW demand or | |
| | | other (meter) to customer | |
| | | and grid | |
| Unit | RT | Operating hour meter | CS, VA, OA, IM, P-T |
| | | reading | |
| Unit | RT | Alarm and notification status | CS, VA, OA, IM, P-T |
| | | (if provided) | |
| Unit | Secondary | Bid/asked pricing on units in | CS, VA, OA, FS, P-T |
| | equipment market | field | |
| | networks | | |

TABLE 2
Exemplary Processing Methods

| Input Data | | | |
|---|---|---|---|
| Category | | | |
| or Type | Processing Method | Cycle | Remarks |
| All | Conversion to Electronic Form | As received | Raw and |
| | Verification (format, | | Processed Data |
| | completeness, etc,( | | Feed Dynamic |
| | Correction/interpolation of | | Rating |
| | missing data | | |
| All Text | Keyword indexing | As received or | Keyword index |
| | Screen for action items and | generated | is a thesaurus |
| | post to Action List | | |
| Client | Security authorization | As received | |
| | Assign code | | |
| | Set up processing parameters | | |
| | for information management | | |
| | (portfolio accounting, billing | | |
| | and operations/alarm) and | | |
| | ASP | | |
| | software | | |
| | Update/Delete (archive) | | |
| Contact | Security authorization | As received | |
| | Set up | | |
| | Update data and links | | |
| Customer | Set up | As received | |
| | Assign code | | |
| | Update/Delete | | |
| Jurisdiction | Define conforming contract | As needed or as | Processed Data |
| | terms | changes | Feed Dynamic |
| | Analyze for needed changes | | Rating |
| | Update for new contract use | | |
| | Issue requests for amendments | | |
| | to clients (where required) | | |
| Product | Security Authorization | As received or as | Raw and |
| | Set Up Record | changes are noted | Processed Data |
| | Assign code | in field, unit or | Feed Dynamic |
| | Format for web presentment | project data | Rating |
| | Review and analyze for action | | |
| | items | | |
| | Confirm with manufacturer | | |
| | Maintain history of | | |
| | engineering changes (if not | | |
| | shared) | | |
| | Maintain Model/SN/EC log (if | | |
| | not shared) | | |
| | Update variables in | | |
| | Technology Actuarial | | |
| | algorithms | | |
| Network | Verify compatibility | As received from | |
| | Interrogate and run test | clients | |
| Organization | Security authorization | As received | |
| | Set up | | |
| | Update data and links | | |
| Project | Set up | As received | Raw and |
| | Verify jurisdiction (initiate | | Processed Data |
| | new jurisdictions data | | Feed Dynamic |
| | collection as required | | Rating |
| | Verify equipment vs. archive | | |
| | (initiate new equipment data | | |
| | collection if required) | | |
| | Compute portfolio accounting | | |
| | and customer billing | | |
| | statements as required | | |
| | Compile and present market | | |
| | statistics (equipment, | | |
| | capacity, | | |
| | jurisdiction, bid/ask) | | |
| Upkeep | Set up maintenance schedule | As received | Raw and |
| | by calendar, run hours and | | Processed Data |
| | other data | | Feed Dynamic |
| | Notify upkeep at milestone | | Rating |
| | Alarm on diagnostics and post | | |
| | Post upkeep records and costs | | |
| | planned and unplanned | | |
| | Compute service payment and | | |
| | update project account and | | |
| | client statement | | |
| | Analyze target accrual rate for | | |
| | equipment type, upkeep | | |
| | provider, and jurisdiction | | |
| | Forecast MTBF | | |
| | Recompute target accrual and | | |
| | value assessment | | |
| | Obtain samples and run | | |
| | laboratory and engineering | | |
| | tests as required | | |
| Unit | Update histories for project | | Raw and |
| | and type | | Processed Data |
| | Analyze trends vs. population | | Feed Dynamic |
| | Review and compute value | | Rating |
| | assessment | | |
| | Compute customer bills and | | |
| | target accrual for client billing | | |
| | Alarm for unplanned service | | |
| | work | | |
| | Compute time-to-planned | | |
| | service | | |
| | Compute portfolio accounting | | |
| | for client and deliver data | | |

### Table 3. Exemplary Jurisdictional Data

Site location: project site locator by ZIP code, tax district code, GPS coordinates, etc.

Document type: related to type of customer (e.g., creditworthiness, etc.) and or type of service (e.g., continuous, prime, standby, backup) in each region

Application: current or intended use of the project at first commercial operation. (e.g., prime, peaking, standby).

Configuration: the initial relationship of the project to the electric grid. (e.g., island, grid supported, grid connected).

System elements: distributed power technologies employed. (e.g., reciprocating engine, turbine, fuel cell, photovoltaic, flywheel or other storage, etc.) including manufacturer, model number, and serial number (when available).

System fuel(s): fuel(s) used by each system element.

Onsite fuel storage: amount of fuel storage by type, ownership of storage, ratings, inspections.

Monitoring and controls: the information management systems, their functions and users, and the types of data monitored, access frequency, interface standards and data storage for each function and user.

Communication network(s): the means (e.g., POTS, wireless, Ethernet, wide area network, etc.) and the recipients of data. Interface protocols. Network availability for backup.

System operating plan: how each element in the system is intended to be operated and controlled.

Customer (end user) enterprise category: segment or category (e.g., small to medium enterprise, healthcare, government agency, institution). Specific procurement, contracting and financing rules that apply.

Customer credit rating: independent rating of end user customer's creditworthiness.

Ownership: identity and nature of site ownership (e.g., own outright, liens, lease, etc.) If leased, the term of the lease and renewal and leasehold improvement provisions.

Provider: the provider's name and type of business model operated (e.g., design-build firm, developer, manufacturer, equipment sales/service dealer, etc.)

Offer: the type of business arrangement the provider is using (e.g., capital project sale, performance contract, aggregation contract, outsourced utility contract).

Term, exercise date and duration: the term of the offer (years) and renewal arrangements, the desired exercise date for Project Value Assurance (months after commercial operation), and the duration (months) that the project can remain at the site after the owner exercises Project Value Assurance option.

Country: site location (e.g., US, Canada, Mexico).

NERC region: NERC (US National Electric Reliability Council) region setting energy delivery rules, FERC interface, ISO in which site is located. Similar parameters for other countries.

EPA Region: EPA (Environmental Protection Agency) enforcement, permitting in which site is located. While federal rules and regulations are uniformly applicable, enforcement emphasis and strategies vary among regions. Similar parameters for other countries.

DOT Region: DOT (Department of Transportation) safety practices and enforcement in region which site is located and in which fuels are delivered. While federal rules and regulations are uniformly applicable, enforcement emphasis and strategies vary among regions. Similar parameters for other countries.

OSHA Region: OSHA (Occupational Safety and Health Administration) work practices and enforcement. Region in which site is located. While federal rules and regulations are uniformly applicable, enforcement emphasis and strategies vary among regions. Similar parameters for other countries.

State or province: taxation (various), public utilities commission policies (agency names vary by state), environmental protection and permitting (agency names vary by state), real property laws, financing rules, engineering standards, work safety, building codes, siting, permitting, fuel storage, and other.

Air quality management district: a geographical area defined by state or province with specific applicable standards for permitting and enforcement of federal, state/provincial and district air quality standards.

Emissions site: the designation of a site if it is part of a larger air emissions permit “bubble.” Constraints, coordination, cross referencing to the master permit.

Oil “zone” (if oil used as fuel): the economic delivery area for liquid petroleum fuels. Delivery infrastructure, costs, rules, reliability, supply points (e.g., pipelines, ports or terminals) competitors, constraints.

Propane “zone” (if propane used as fuel): the economic delivery area for other liquid fuels. Delivery infrastructure, costs, rules, reliability, competitors, constraints.

Gaseous fuel “zone”: the economic delivery area for gaseous fuels including byproducts including natural gas, hydrogen or other. Delivery infrastructure, costs, rules, reliability, competitors, constraints.

Electric distribution utility (EDU): the EDU franchise area in which the end user and Site are located. With public utility commission in state sets tariffs, safety, reliability, transmission, distribution, billing, metering, interconnection.

Electric control area: the point on the EDU's grid that the site is located or may have access to transmission, distribution, technical limits.

LMP Node: LMP (locational marginal pricing) node is a point on the EDU's grid that has defined pricing and load serving characteristics within a larger electric control area.

Gas distribution utility (GDU): the regulated distributor of natural gas. GDU franchise area in which the end user and site are located. With public utility commission in state sets tariffs, safety, reliability, transmission, distribution, billing, metering, interconnection.

City gate(s): the points at which the GDU takes delivery of natural gas from an interstate pipeline that will serve the site. Defines fuel delivery, reliability, pipeline costs for transporting fuel, constraints.

GDU distribution point(s): the point(s) on the GDU's system that serve the Site. This point defines the meter number, meter capacity, various meter parameters, and the maximum available natural gas delivery pressure at the Site.

County, parish, township: the political subdivision of the state or province in which the Site is located that defines tax, permitting, engineering, operating codes and standards.

Planning or zoning unit: geographical area defined by state, provincial or political subdivisions with power to review and enforce permitting and siting standards for facilities and various rule making authority which has authority for the site. For example, California has a large number of these local units that do not always correspond line-for-line with other political boundaries.

City or town: work rules, permitting, tax, engineering, building codes, electrical codes, fire codes and standards, public health standards, operating ordinances, siting and permitting.

Tax district: state, county or town defined geographic areas for taxation of assets, property, sales, etc. in which the site is located.

While only certain preferred embodiments and features of the invention have been illustrated and described herein, many modifications and changes will occur to those skilled in the art. It is, therefore, to be understood that the appended claims are intended to cover all such modifications and changes as fall within the range of equivalents and understanding of the invention.

What is claimed is:

1. A method for producing a pricing option corresponding to an economic risk in a multi-component distributed power project, comprising:
collecting operational data corresponding to at least one component of the distributed power project;
obtaining historical data corresponding to said at least one component from a historical data source;
performing a processing function according to a model, which uses the operational data and the historical data, to yield an output corresponding to a future residual value of the at least one component; and
presenting a user with a pricing option for the distributed power assurance service, based at least in part on the future residual value of the at least one component.

2. The method of claim 1, wherein the model is executed on a computer processor.

3. The method of claim 1, further comprising calculating a pricing option for the multi-component distributed power project based at least in part on calculated future residual values of a plurality of components.

4. The method of claim 1, wherein collecting the operational data comprises collecting real-time measurement data obtained through instruments coupled to running equipment.

5. The method of claim 1, wherein collecting the operational data comprises collecting data from equipment operation logs.

6. The method of claim 1, wherein collecting the operational data comprises collecting data from equipment maintenance logs.

7. The method of claim 1, wherein collecting the operational data comprises collecting data relating to any of: ambient conditions data, fuel efficiency data and equipment duty-cycle data.

8. The method of claim 1, wherein the act of obtaining the operational data comprises obtaining data from any of: a database, the World Wide Web, the Internet, a local area network and a wide area network.

9. The method of claim 1, wherein the act of obtaining the operational data comprises obtaining data through a land-line communication connection or a wireless communication connection.

10. The method of claim 1, wherein the act of presenting the user with the pricing option is performed using an application service portal (ASP) which the user logs on to for gaining access to the pricing option.

11. The method of claim 1, further comprising collecting jurisdictional data from a jurisdictional data source corresponding to the distributed power project and using the jurisdictional data in determining the pricing option.

12. The method of claim 1, wherein collecting the operational data comprises collecting real-time data from operations within the project.

13. The method of claim 1, further comprising presenting the pricing option to the user as parameters inserted into a standardized document.

14. The method of claim 1, further comprising adaptively updating the model based on the operational data.

15. The method of claim 1, further comprising preparing a standardized assurance document containing information regarding said pricing option.

16. The method of claim 1, further comprising providing the future residual value of the at least one component to an underwriter and the underwriter using the future residual value to mitigate a calculation of the economic risk, said economic risk faced by a party relying on an underwriting evaluation of the project.

17. The method of claim 1, further comprising providing results from the model to an underwriting entity.

18. The method of claim 1, further comprising mitigating economic risks associated with owning or operating or financing the project.

19. A system for pricing assurance services for a multi-component distributed power project, said project having at least one distributed power component, the system comprising:
a source of operational data corresponding to the component;
a source of historical data corresponding to the component;
a computer processing engine that receives the operational data and the historical data and uses a model to produce a pricing option corresponding to an assurance service for the project; and
a server, receiving the pricing option from the computer processing engine, coupled to a network and running an application service portal (ASP) application by which a user can receive the pricing option from the server.

20. The system of claim 19, wherein the network is the Internet.

21. The system of claim 19, further comprising an instrument coupled to the component, said instrument adapted for providing measurement information related to operation of the component.

22. The system of claim 19, wherein the server delivers the pricing option to the user in the form of a standardized document.

23. The system of claim 19, further comprising a market exchange unit, coupled to the network, said market exchange unit executing transactions for the transfer of equipment and services relating to the distributed power project.

24. A method for quantifying an economic risk to an underwriter insuring a multi-component distributed power project, comprising:
collecting operational data corresponding to a component of the multi-component distributed power project;
obtaining historical data corresponding to the component of the multi-component distributed power project;
estimating a remaining useful life of the component at least as a function of the operational data and the historical data;
estimating a future residual value of the project at least as a function of the remaining useful life of the component; and
determining the economic risk for the underwriter as a function of at least the future residual value of the project.

25. An application service portal (ASP), comprising:
a processing engine receiving operational data and historical data corresponding to a component of a multi-component distributed power project, the processing engine adapted for carrying out calculations to yield a pricing option using the operational and the historical data;
a World Wide Web server accessible to a client over a network, the server receiving results of the calculations from the processing engine;
wherein the ASP presents said pricing option to said client.

26. The method of claim 25, wherein the calculations are actuarial calculations.

27. The ASP of claim 25, wherein the processing engine further receives jurisdictional data corresponding to a jurisdiction in which the project operates, and wherein the jurisdictional data is used by the processing engine to yield the pricing option.

28. A method for estimating an economic risk associated with a contract for sale or service of a multi-component distributed power project, comprising:
breaking the multi-component project into at least two discrete components;
collecting live operational data corresponding to at least one of the at least two discrete components;
collecting historical data corresponding to said at least one discrete component;
estimating the useful remaining life of said at least one discrete component;
estimating the residual value of the at least one discrete component at a future date;
estimating the residual value of the project based at least on the estimated residual value of the at least one discrete component; and
estimating the economic risk associated with the contract based at least on the estimated residual value of the project.

29. A method for underwriting a distributed power project, comprising:
dividing the project into discrete components which can be analyzed individually;
estimating a remaining useful life of at least one discrete component of the project based at least on operational data and historical data corresponding to the discrete component;
estimating an accrual rate for upkeep services associated with maintaining the at least one discrete component;
using the remaining useful life and the upkeep accrual rate to calculate a residual value for the at least one discrete component; and
providing an option for underwriting the distributed power project based at least on the residual value.

30. The method of claim 29, wherein the operational data comprises data relating to any of: ambient conditions data, fuel efficiency data and equipment duty-cycle data.

31. The method of claim 29, further comprising collecting jurisdictional data from a jurisdictional data source corresponding to the distributed power project and using the jurisdictional data in underwriting the project.

32. The method of claim 29, further comprising placing funds from a client into an escrow account and using the funds as a guarantee that upkeep practices comport with an upkeep standard.

33. The method of claim 29, further comprising forming a contract between an upkeep assurance unit and a maintenance provider such that the maintenance provider receives upkeep business in exchange for returning upkeep data to the upkeep assurance unit.

34. The method of claim 29, further comprising providing the residual value to an underwriter and using the future residual value to mitigate an economic risk.

35. A system for providing project value assurance services in a distributed power project, comprising:
a jurisdictional knowledge unit that receives and parses information relating to a jurisdiction within which the distributed power project resides;
an economic processing engine, receiving information from the jurisdictional knowledge unit, said economic processing engine performing calculations; and
a user interface, receiving an output from the economic processing engine, said user interface providing a user with a standardized document in response to user input containing information about the project and the jurisdiction in which the project lies.

36. The system of claim 35, further comprising an upkeep assurance unit that assures a minimum level of maintenance for equipment associated with the project according to some pre-defined maintenance schedule.

37. The system of claim 35, further comprising an escrow unit for maintaining funds related to upkeep of the equipment.

38. The system of claim 35, further comprising a market exchange unit that facilitates transfer of assets from one owner to another owner.

39. The system of claim 35, further comprising a jurisdictional database coupled to the jurisdictional knowledge unit, said database containing information relating to rules in a plurality of jurisdictions.

40. A method for producing a pricing option corresponding to an economic risk in a multi-component distributed power project, comprising:
collecting operational data corresponding to at least one component of the distributed power project;
obtaining historical data corresponding to said at least one component from a historical data source;
performing a processing function according to a model, which uses the operational data and the historical data, to yield an output corresponding to a future residual value of the distributed power project; and
presenting a user with a pricing option for the distributed power assurance service, based at least in part on the future residual value of the at least one component.
